(19) United States
(12) Patent Application Publication
(10) Pub. No.: US 2026/0217956 A1
(43) Pub. Date: Jul. 30, 2026

(54) RECYCLATE POLYETHYLENE COMPOSITION WITH IMPROVED MECHANICAL AND OPTICAL PROPERTIES

(71) Applicant: Borealis GMBH, Vienna (AT)

(72) Inventors: Yi Liu, Linz (AT); Hermann Braun, Linz (AT); Elisabeth Ribarits, Stenungsund (SE)

(21) Appl. No.: 19/148,813

(22) PCT Filed: Jan. 18, 2024
(86) PCT No.: PCT/EP2024/051176

§ 371 Date: Jul. 17, 2025

(30) Foreign Application Priority Data
Jan. 18, 2023 (EP) 23152209.5

(51) Int. Cl. C08L 23/08; B29B 17/00; B29B 17/02; B29B 17/04; B29K 23/00; B29K 105/00; C08J 11/06

(52) U.S. Cl. CPC C08L 23/08; C08J 11/06; B29B 2017/0015; B29B 2017/0203; B29B 2017/0224; B29B 17/0412; B29K 2023/08; B29K 2105/0094; B29K 2995/0063; B29K 2995/007; C08J 2323/08; C08L 2203/202; C08L 2205/025; C08L 2205/03; C08L 2207/20; C08L 2310/00

(57) ABSTRACT

The present invention relates to a mixed-plastic recyclate polyethylene composition having a melt flow rate (ISO 1133, 2.16 kg, 190° C.) of from 0.1 to 1.5 g/10 min; and a density of from 938 to 985 kg/m³, and comprising 35 wt.-% or more of a recycled polyethylene fraction (rPE), wherein the mixed-plastic recyclate polyethylene composition has (a) a total amount of ethylene units (C2 units) of at least 95.0 wt.-%, as measured by ¹³C-NMR of the d2-tetrachloroethylene soluble fraction; (b) a total amount of continuous C3 units originating from polypropylene (PP) in an amount of from 0 to 3.0 wt.-%, determined by quantitative ¹³C{1H}-NMR measurement of the soluble fraction; and (c) an environmental stress crack resistance (ESCR) according to the Bell test, in accordance with IEC 60811-406, method B of at least 1000 h failure time, wherein the mixed-plastic recyclate polyethylene composition further comprises at least one virgin polyethylene component (B), optionally blended with carbon black, and optionally a virgin polyethylene component (B1), different from virgin polyethylene component (B), optionally blended with carbon black, wherein the mixed-plastic recyclate polyethylene composition has a tear resistance, determined according to BS 6469 section 99.1 of at least 24 N/mm. Such a mixed-plastic recyclate polyethylene composition has high purity in terms of polyethylene content, low content of contaminants, high homogeneity, improved mechanical properties, and good optical properties. The present invention further relates to a method for its preparation, to the above recycled polyethylene fraction (rPE), obtainable or obtained by a method of recycling a mixed-plastic recycling stream, to an article made from the above mixed-plastic recyclate polyethylene composition, and to the use of the above mixed-plastic recyclate polyethylene composition for wire and cable applications.

The present invention relates to mixed-plastic recyclate polyethylene compositions originating from post-consumer recyclates (PCR).

### BACKGROUND OF THE INVENTION

The challenge of disposal of accumulated plastic waste and corresponding environmental issues have received widespread attention from the public and industry. Therefore, recycling of plastic material has become an important topic, where plastic waste can be turned into valuable resources for new plastic products. Hence, environmental and economic aspects can be combined in recycling and reusing plastic material.

Although recycling of plastic material has already begun in the mid-90s by implementing collection systems, which allow more target orientated collection and separation of plastic materials from other household waste materials, the reuse of plastic material originating from plastic waste is still limited. The so-called post-consumer recyclates (PCR) generally contains mixtures of different plastics and several contaminant materials. Methods have been developed to further purify the post-consumer recyclates (PCR).

Many attempts have been made for purifying recycling streams as originating from post-consumer plastic waste. Among those measures washing, sieving, aeration, distillation and the like may be mentioned. For example, WO2018/046578 A1 discloses a process for the production of polyolefin recyclates from mixed color polyolefin waste including packaging waste comprising cold washing the waste with water followed by washing with an alkali medium at 60° C., followed by flake color sorting to receive color sorted mono polyolefin rich fractions.

WO 2021/074 785 A1 discloses polyethylene blends made from recycled polyethylene suitable for compression moulding or injection moulding applications, the recycled polyethylene comprising from 1 wt.-% to 50 wt.-% recycled polyethylene and from 50 wt.-% to 99 wt.-% of a bimodal polyethylene composition, wherein the recycled polyethylene has a density from 0.916 to 0.970 g/cm³ as measured by ASTM D792, and a melt index 12, as determined by ASTM D1238 at 190° C. using a 2.16 kg load from 0.3 to 30 g/10 min, and wherein the bimodal polyethylene composition has a density from 0.930 to 0.970 g/cm³ as measured by ASTM D792, and a melt index, I₂, as determined by ASTM D1238 at 190° C. using a 2.16 kg load from 0.1 to 12 g/10 min and a B10 ESCR as determined by ASTM D1693 from 10 to 2000 h time to failure.

WO 2021/233818 A1, WO 2021/233819 A1 and WO 2021/233820 A1 disclose polyethylene recyclate compositions comprising virgin high-density polyethylenes (HDPE) suitable as jacketing materials that have acceptable ESCR (Environmental Stress Crack Resistance) performance. All three disclosures use a mixture of at least 50 wt.-% of a virgin HDPE component and a commercial source of a PCR polyethylene, which has an amount of continuous C3 units (PP) of more than 10 wt.-%. Such a recyclate polyethylene has shown inadequate ESCR performance and suffers from high amounts of contaminations. Contamination of a recycled polymer generally means impurities from the first application of the virgin polymer or foreign materials which are not removed in the purification steps of recycling (Management, Recycling and Reuse of Waste Composites, Vannessa Goodship, Woodhead Publishing, 2010). Examples include foreign polymers (e.g., PP, PET, PA in a recycled polyethylene), metal traces (e.g., rust), contact media (e.g. oil, fat), inorganic impurities (e.g., dust, sand), organic impurities (e.g., inks, paints, adhesives), etc.

Thus, there is still a strong need for recycled materials with properties as close as possible to virgin resins. In particular, it is the object of the present invention to provide PE-PCR materials, which are superior to existing materials in high purity of the product in terms of polyethylene content, low content of contaminants, high homogeneity, improved mechanical properties such as ESCR performance, tear resistance, good tensile and impact properties, and good optical properties.

### SUMMARY OF THE INVENTION

The objects underlying the present invention are to provide a mixed-plastic recyclate polyethylene composition that addresses the above-described needs and disadvantages.

These objects are achieved by the provision of a mixed-plastic recyclate polyethylene composition that addresses the above-described needs and disadvantages.

Accordingly, the present invention provides a mixed-plastic recyclate polyethylene composition having a melt flow rate (ISO 1133, 2.16 kg, 190° C.) of from 0.1 to 1.5 g/10 min; and a density of from 938 to 985 kg/m³, and comprising 35 wt.-% or more of a recycled polyethylene fraction (rPE);
wherein the mixed-plastic recyclate polyethylene composition has:
(a) a total amount of ethylene units (C2 units) of at least 95.0 wt.-%, as measured by ¹³C-NMR of the d2-tetrachloroethylene soluble fraction, as described in the experimental section below;
(b) a total amount of continuous C3 units originating from polypropylene (PP) in an amount of from 0 to 3.0 wt.-%, determined by quantitative ¹³C{1H}-NMR measurement of the soluble fraction, as described in the experimental section below; and
(c) an environmental stress crack resistance (ESCR) according to the Bell test, in accordance with IEC 60811-406, method B and as described in the experimental section below of at least 1000 h, preferably at least 2500 h failure time,
   wherein the mixed-plastic recyclate polyethylene composition further comprises:
   at least one virgin polyethylene component (B), optionally blended with carbon black, and optionally a virgin polyethylene component (B1), different from virgin polyethylene component (B), optionally blended with carbon black,
   wherein the mixed-plastic recyclate polyethylene composition has a tear resistance, determined according to BS 6469 section 99.1 of at least 24 N/mm.

The above recycled polyethylene fraction (rPE) is obtainable or obtained by a method of recycling a mixed-plastic recycling stream comprising the steps of:
a) providing a mixed-plastic recycling stream (A);
b) sieving the mixed-plastic recycling stream (A) to create a sieved mixed-plastic recycling stream (B) having only articles with a longest dimension in the range from 30 to 400 mm;
c) sorting the sieved mixed-plastic recycling stream (B) by means of one or more sorting systems equipped with near infrared (NIR) and optical sensors wherein the sieved mixed-plastic recycling stream (B) is sorted at least by polymer type and color, generating a mixed-color or other-color (e.g., natural and white) sorted polyethylene recycling stream (CM) that is subjected separately to steps d) and beyond;
d) shredding the sorted polyethylene recycling stream (CM) to form a flaked polyethylene recycling stream (D);
e) washing the flaked polyethylene recycling stream (D) with a first aqueous washing solution (W1) without the input of thermal energy, thereby generating a first suspended polyethylene recycling stream (E);
f) removing at least part of the first aqueous washing solution (W1) from the first suspended polyethylene recycling stream (E) to obtain a first washed polyethylene recycling stream (F);
g) washing the first washed polyethylene recycling stream (F) with a second aqueous washing solution (W2) thereby generating a second suspended polyethylene recycling stream (G), wherein sufficient thermal energy is introduced to the second suspended polyethylene recycling stream (G) to provide a temperature in the range from 65 to 95° C. during the washing;
h) removing the second aqueous washing solution (W2) and any material not floating on the surface of the second aqueous washing solution from the second suspended polyethylene recycling stream (G) to obtain a second washed polyethylene recycling stream (H);
i) drying the second washed polyethylene recycling stream (H), thereby obtaining a dried polyethylene recycling stream (I);
j) optionally separating the dried polyethylene recycling stream (I) into a light fraction and a heavy fraction polyethylene recycling stream (J) by windsifting;
k) optionally sieving the polyethylene recycling stream;
l) optionally further sorting the heavy fraction polyethylene recycling stream (J) or, in the case that step j) is absent, the dried polyethylene recycling stream (I) by means of one or more optical sorters sorting for one or more target polyethylenes by removing any flakes containing material other than the one or more target polyethylenes, yielding a purified polyethylene recycling stream (K);
m) optionally melt extruding, preferably pelletizing, the purified polyethylene recycling stream (K), preferably wherein additives (Ad) are added in the melt state, to form an extruded, preferably pelletized, recycled polyethylene product (L); and
n) optionally aerating the recycled polyethylene product (L) or, in the case that step
l) is absent, the purified polyethylene recycling stream (K) to remove volatile organic compounds, thereby generating an aerated recycled polyethylene product (M), being either an aerated extruded, preferably pelletized, recycled polyethylene product (M1) or aerated recycled polyethylene flakes (M2),
   wherein the order of steps n) and m) can be interchanged, such that the purified polyethylene recycling stream (K) is first aerated to form aerated recycled polyethylene flakes (M2) that are subsequently extruded, preferably wherein additives (Ad) are added in the melt state, to form an extruded, preferably pelletized, aerated recycled polyethylene product (M3), which is the above recycled polyethylene fraction (rPE).

The present invention further relates to a method of preparing the above mixed-plastic recyclate polyethylene composition, comprising the steps of melting, blending and extruding the recycled polyethylene fraction (rPE), at least one virgin high density polyethylene component (B), and optionally a virgin polyethylene component (B1) in an extruder, with a screw speed of not more than 400 rpm, preferably not more than 350 rpm.

The present invention further relates to a mixed-plastic recyclate polyethylene composition obtainable or obtained by a method comprising the steps of melting, blending and extruding in an extruder, with a screw speed of not more than 400 rpm, preferably not more than 350 rpm, of at least 35.0 wt.-% of the recycled polyethylene fraction (rPE), and at least 20 wt.-% of a virgin polyethylene component, selected from at least one virgin polyethylene component (B) optionally blended with carbon black, and a virgin polyethylene component (B1), different from virgin polyethylene component (B), optionally blended with carbon black.

The present invention further relates to an article, preferably a jacketing material of a power cable made from the above mixed-plastic recyclate polyethylene composition, whereby said mixed-plastic recyclate polyethylene composition amounts to at least 85 wt.-% of the total composition for making the article.

The present invention further relates to the use of the above mixed-plastic recyclate polyethylene composition for wire and cable applications.

### BRIEF DESCRIPTION OF THE FIGURE

FIG. 1 illustrates strain hardening factor (STF) as a function of Eta0.05 of the recyclate compositions of the examples vs. the virgin polyethylene components (B)/(B1) alone to express processability of the samples at a given complex viscosity. As the virgin polyethylene components, the polymers according to PE1, PE2, PE3, PE4, PE5, PE7 and PE8 identified in the example section were used.

### DETAILED DESCRIPTION OF THE INVENTION

### Definitions

For the purposes of the present description and of the subsequent claims, the term “recycling stream” is used to indicate a material processed from post-consumer waste as opposed to virgin polymers and/or materials. Post-consumer waste refers to objects having completed at least a first use cycle (or life cycle), i.e. having already served their first purpose. The term “virgin” denotes the newly produced materials and/or objects prior to their first use, which have not already been recycled. The term “recycled material” such as used herein denotes materials reprocessed from a post consumer waste or a recycling stream.

A blend denotes a mixture of two or more components, wherein at least one of the components is polymeric. In general, the blend can be prepared by mixing the two or more components. Suitable mixing procedures are known in the art. If such a blend includes a virgin material, said virgin material preferably is a polyethylene comprising at least 90 wt.-% of a reactor made polyethylene material, as well as optionally carbon black. A virgin material is a polymeric material which has not already been recycled.

For the purposes of the present description and of the subsequent claims, the term “mixed-plastic recyclate polyethylene composition” or “recycled polyethylene fraction (rPE)” indicates a polymer material including predominantly units derived from ethylene apart from other polymeric ingredients of arbitrary nature. Such other polymeric ingredients may for example originate from monomer units derived from alpha-olefins such as propylene, butylene, octene, and the like, styrene derivatives such as vinylstyrene, substituted and unsubstituted acrylates, substituted and unsubstituted methacrylates.

Said other polymeric materials can be identified in the mixed-plastic recyclate polyethylene composition by means of quantitative ¹³C{1H} NMR measurements as described herein. In the quantitative ¹³C{1H} NMR measurement used herein and described below in the measurement methods different units in the polymeric chain can be distinguished and quantified. These units are ethylene units (C2 units), and units having 3, 4, 6 or 7 carbon atoms. Thereby, the units having 2 carbon atoms (C2 units) can be distinguished in the NMR spectrum as isolated C2 units and as continuous C2 units which indicate that the polymeric material contains an ethylene based polymer. The mixed-plastic recyclate polyethylene composition according to the present invention usually includes low amounts of propylene-based polymeric components, particularly low amounts of continuous C3 units originating from polypropylene (PP), which can be determined by ¹³C-NMR analysis of the soluble fraction, as described in the experimental section below.

The term “C2 fraction” denotes repetitive —[C₂H₄]— units derived from ethylene which are present in the linear chains backbone and the short chain branches as measured by quantitative ¹³C{¹H} NMR spectroscopy, whereby repetitive means at least two units.

The C2 fraction can be calculated as

$${wt}_{C 2 fraction} = {fC}_{C 2 total} * 100 / ( {fC}_{C 2 total} + {fC}_{PP} )$$

whereby

$${fC}_{C 2 total} = ( Iddg - ItwoB 4 ) + ( IstarB 1 * 6 ) + ( IstarB 2 * 7 ) + ( ItwoB 4 * 9 ) + ( IthreeB 5 * 10 ) + ( ( IstarB 4 plus - ItwoB 4 - IthreeB 5 ) * 7 ) + ( I 3 s * 3 )$$

$$and$$

$${fC}_{PP} = Is αα * 3$$

Details are given in the experimental part below.

### Recyclate Compositions

HDPE, LDPE or LLDPE, homo- and copolymer polyethylenes may be present in the recyclate compositions of the present invention. The polyethylenes may be characterized by analytical separation. An adequate method is Chemical Composition Analysis by Cross fractionation Chromatography (CFC). This method has been described and successfully implemented by Polymer Char, Valencia Technology Par, Gustave Eiffel 8, Paterna E-46980 Valencia, Spain. Chemical Composition Analysis by Cross Fractionation Chromatography (CFC) allows fractionation into a homopolymer fraction (HPF) and a copolymer fraction (CPF) and a potentially present iso-PP fraction (IPPF). The homopolymer fraction (HPF) is a fraction including polyethylenes similar to homopolymer-HDPE. The copolymer fraction (CPF) is a fraction similar to polyethylene HDPE copolymer but can also include fractions of LDPE respectively LLDPE. The iso-PP fraction (IPPF) includes isotactic polypropylene and is defined as the polymer fraction eluting at a temperature of 104° C. and above. The homopolymer fraction (HPF), the copolymer fraction (CPF) and the potentially present iso-PP fraction (IPPF) add up to 100 wt.-%. It is self-explaining the 100 wt.-% refer to the material being soluble within the Cross Fractionation Chromatography (CFC) experiment.

In addition to Chemical Composition Analysis by Cross Fractionation Chromatography (CFC), the mixed-plastic recyclate polyethylene composition according to the present invention is also characterized by a C2 fraction in an amount of at least 95.0 wt.-%, preferably at least 97.0 wt.-% as measured by ¹³C-NMR of the d2-tetrachloroethylene soluble fraction. The percentage refers to the d2-tetrachloroethylene soluble part as used for the NMR experiment. The term “C2 fraction” equals the polymer fraction obtainable from ethylene monomer units, i.e. not from propylene monomer units.

The upper limit of the “C2 fraction” is 100 wt.-%.

Conventionally, further components such as fillers, including organic and inorganic fillers for example talc, chalk, carbon black, and further pigments such as TiO₂ as well as paper and cellulose may be present in the mixed-plastic recyclate polyethylene composition of the invention.

The mixed-plastic recyclate polyethylene composition according to the present invention has a melt flow rate MFR₅ (ISO1133, 5.0 kg; 190° C.) of 0.1 to 10.0 g/10 min. The melt flow rate can be influenced by splitting post-consumer plastic waste streams, for example, but not limited to: originating from extended producer's responsibility schemes, like from the German DSD, or sorted out of municipal solid waste into a high number of pre-sorted fractions and recombine them in an adequate way. Preferably, MFR₅ ranges from 0.5 to 5.0 g/10 min, more preferably from 0.7 to 4.0 g/10 min, and even more preferably from 1.0 to 3.0 g/10 min can be used.

The presence of carbon black has an influence on the density of the composition. The mixed-plastic recyclate polyethylene composition according to the present invention may comprise carbon black or pigments, preferably carbon black in an amount of not more than 5 wt.-%, more preferably not more than 3 wt.-%. The lower limit of carbon black is preferably at least 1.0 wt.-%, more preferably at least 2.0 wt.-%.

With carbon black, the mixed-plastic recyclate polyethylene composition according to present invention has a density of from 950 to 985 kg/m³, preferably from 952 to 975 kg/m³, more preferably from 954 to 972 kg/m³, determined according to ISO1183.

Without carbon black, the mixed-plastic recyclate polyethylene composition according to present invention has a density of from 938 to 973 kg/m³, preferably from 940 to 963 kg/m³, more preferably from 942 to 960 kg/m³, which translates into improved processability of the compositions, compared to the pure virgin polyethylene components at a given value of Eta_{0.05}.

The mixed-plastic recyclate polyethylene composition of the present invention preferably has a white spot rating (WSR), determined according ISO 18553 and as described herein, of not more than 5.0, more preferably of not more than 4.0.

The mixed-plastic recyclate polyethylene composition of the present invention preferably has a tensile strain at break, determined according to ISO 527-2 on 5 A specimens of at least 670%, more preferably at least 700%. In certain embodiments the mixed-plastic recyclate polyethylene composition of the present invention may have a tensile strain at break of at least 750%. The mixed-plastic recyclate polyethylene composition according to the present invention may preferably have a tensile strain at break of not more than 1200%.

The mixed-plastic recyclate polyethylene composition of the present invention preferably has a tear resistance, determined according to BS 6469 section 99.1. of at least 24 N/mm, more preferably at least 25 N/mm, even more preferably at least 26 N/mm, and still more preferably at least 26.3 N/mm. The mixed-plastic recyclate polyethylene composition of the present invention may also have a tear resistance of at least 27.0 N/mm. Preferably, the mixed-plastic recyclate polyethylene composition of the present invention has a tear resistance of not more than 50 N/mm.

The mixed-plastic recyclate polyethylene composition according to the present invention may preferably have a Large Amplitude Oscillatory Shear-Non-Linear Factor (LAOS-NLF), determined at 190° C. and a strain of 1000%, as described in the experimental section

$$LAOS - NLF = \vert \frac{{G}_{1}^{′}}{{G}_{3}^{′}} \vert$$

whereby
G1′ is the first order Fourier Coefficient
G3′ is the third order Fourier CoefficentCoefficient
in the range of 2.0 to 4.0, more preferably in the range of from 2.3 to 3.8
LAOS-NLF is a rheological measure of the long chain branching content and further indicates non-linear polymer structure. A higher value of LAOS-NLF indicates a higher content of long chain branching.

The mixed-plastic recyclate polyethylene composition according to the present invention may preferably have a strain hardening modulus, determined according to ISO 18488 and as described herein, of 10 MPa or higher, preferably 12 MPa or higher, and/or may have a Shore D hardness (15 s), determined according to ISO 868 and as described in the experimental section below, of at least 57, preferably at least 57.5. The mixed-plastic recyclate polyethylene composition according to the present invention may preferably have a Shore D hardness (15 s) of not more than 67.

Strain hardening modulus is a measure for slow crack growth resistance and Shore D hardness is a measure of the hardness of the material.

The mixed-plastic recyclate compositions of the present invention preferably exhibit a relationship between strain hardening factor (STF) and complex shear viscosity at an angular frequency of 0.05 rad/s (Eta_{0.05}) within a range of Eta_{0.05} from 10,000 to 100,000 Pa·s, according to the following inequation:

$$STF > 0.0009 * {Eta}_{0.05} ( Pa \cdot s ) + 9.$$

Preferably, the relationship fulfils STF>0.0009*Eta_{0.05} (Pa·s)+12 and more preferably the relationship fulfils STF>0.0009*Eta_{0.05} (Pa·s)+14.

Preferably, the complex shear viscosity Eta_{0.05} is in a range of from 19,000 to 80,000 Pa·s, more preferably from 20,000 to 70,000 Pa·s.

The above relationship between STF and Eta_{0.05} translates into improved processability of the compositions, compared to the pure virgin polyethylene components at a given value of Eta_{0.05}.

The mixed-plastic recyclate polyethylene composition according to the present invention comprises 35 wt.-% or more of a recycled polyethylene fraction (rPE), the latter being preferably obtained from post-consumer recyclates (PCR). Such PCR materials are typically obtained from consumer waste streams, such as waste streams originating from conventional collecting systems such as those implemented in the European Union (e.g. extended producer responsibility schemes, EPR schemes). PCR materials may also be derived from municipal solid waste originating outside of EPR collection systems.

The feedstock materials for obtaining the recycled polyethylene fraction (rPE) used in the present invention may be selected from a wide range of fractions generated from municipal solid waste (MSW, also often referred to as residual waste, black bin waste) to Extended Producer Responsibility (EPR)-based feedstocks, for example the ARA 402 fraction from Altstoff Recycling Austria or the DSD 329 fraction from German Producer Responsibility Organisations, such as DSD—Duales System Holding, Interzero, Reclay.

It is preferred that the mixed-plastic recyclate polyethylene composition according to the present invention, comprises at least 40 wt.-%, more preferably at least 45 wt.-%, even more preferably at least 50 wt.-% of the recycled polyethylene fraction (rPE).

The mixed-plastic recyclate polyethylene composition according to the present invention is obtainable or is obtained according to a method comprising the steps of melting, blending and extruding in an extruder, with a screw speed of not more than 400 rpm, preferably not more than 350 rpm of at least 35.0 wt.-% of the recycled polyethylene fraction (rPE) defined herein, and at least 20 wt.-% of a virgin polyethylene component, selected from at least one virgin polyethylene component (B) optionally blended with carbon black, and a virgin polyethylene component (B1), different from virgin polyethylene component (B), optionally blended with carbon black. According to a preferred embodiment, the mixed-plastic recyclate polyethylene composition comprises said recycled polyethylene fraction (rPE) and said at least one virgin polyethylene component (B) optionally blended with carbon black and excludes said virgin polyethylene component (B1).

The mixed-plastic recyclate polyethylene composition according to the present invention can comprise further components apart from the recycled polyethylene fraction (rPE), the at least one virgin polyethylene component (B), and the optional virgin polyethylene component (B1), such as further polymeric components or additives in amounts of not more than 15 wt.-%, based on the total weight of the composition. Suitable additives are usual additives for utilization with polyolefins, such as stabilizers, (e.g. antioxidant agents), metal scavengers and/or UV stabilizers, antistatic agents, and utilization agents. The additives can be present in the composition in an amount of 10 wt.-% or below, more preferably 9 wt.-% or below, more preferably 7 wt.-% or below. Carbon black or other pigments are not enclosed in the definition of additives.

The steps of melting, blending and extruding may preferably be conducted as described in WO 2021/122299 A1.

Recycled Polyethylene Fraction (rPE)

The recycled polyethylene fraction (rPE) is contained in the mixed-plastic recyclate polyethylene composition according to the present invention in an amount of at least 35 wt.-%, preferably at least 40 wt.-%, more preferably at least 45 wt.-%, based on the total weight of the final composition. The recycled polyethylene fraction (rPE) may preferably be contained in the mixed-plastic recyclate polyethylene composition according to the present invention in an amount of not more than 80 wt.-%, more preferably not more than 75 wt.-%, even more preferably not more than 70 wt.-%, based on the total weight of the final composition.

The recycled polyethylene fraction (rPE) used in the present invention has a homopolymer fraction (HPF) content determined according to Chemical Composition Analysis by Cross Fractionation Chromatography (CFC) in the range from 73.0 to 95.0 wt.-%, preferably in the range from 75.0 to 94.0 wt.-%, more preferably in the range from 77.0 to 93.0 wt.-%, even more preferably in the range from 79.0 to 92.0 wt.-%.

The recycled polyethylene fraction (rPE) used in the present invention further has a copolymer fraction (CPF) content determined according to Chemical Composition Analysis Cross Fractionation Chromatography (CFC) in the range from 5.0 to 27.0 wt.-%, preferably in the range from 6.0 to 25.0 wt.-%, more preferably in the range from 7.0 to 23.0 wt.-%, even more preferably in the range from 8.0 to 21.0 wt.-%.

The recycled polyethylene fraction (rPE) used in the present invention further has a total content of heavy metals selected from Cr, Cd, Hg and Pb of not more than 100 ppm, preferably of not more than 80 ppm, more preferably of not more than 50 ppm, with respect to the total recycled polyethylene fraction, as measured by x-ray fluorescence (XRF) as described in the experimental section below.

The recycled polyethylene fraction (rPE) used in the present invention may in some embodiments be a mixed-color polyethylene recycled blend which may have a CIELAB color space (L*a*b*) measured according to DIN EN ISO 11664-4, as described in the experimental section below, of
L* from 30.0 to 73.0;
a* from −10.0 to 25.0;
b* from −5.0 to 20.0.

Preferably, the CIELAB color space (L*a*b*) is defined by
L* from 32.0 to 71.0;
a* from −9.0 to 23.0;
b*from −5.0 to 18.0.

More preferably, the CIELAB color space (L*a*b*) is defined by
L* from 35.0 to 70.0;
a* from −7.0 to 20.0;
b* from −5.0 to 15.0.

The recycled polyethylene fraction (rPE) used in the present invention may in some embodiments be a natural-color polyethylene recycled blend which may have a CIELAB color space (L*a*b*) measured according to DIN EN ISO 11664-4, as described in the experimental section below, of
L* from 55 to 88;
a* from −7.0 to 3.0;
b* from 0.0 to 30.0

Preferably, the CIELAB color space (L*a*b*) is defined by
L* from 75.0 to 86.0;
a* from −5.0 to 0.0;
b* from 5.0 to 25.0

More preferably, the CIELAB color space (L*a*b*) is defined by
L* from 76.0 to 85.0;
a*from −4.0 to −0.1;
b* from 6.0 to 22.0.

The recycled polyethylene fraction (rPE) used in the present invention preferably has a benzene content below the detection limit, determined according to static headspace chromatography mass spectroscopy (HS/GC-MS) at 100° C./2 h, as described in the experimental section below.

The recycled polyethylene fraction (rPE) used in the present invention preferably has an odor (VDA270-B3) of 5.0 or lower, more preferably 4.0 or lower. It should be understood that many commercial recycling grades which do not report odor are in fact even worse, as an odor test according to VDA270 is forbidden due to the presence of problematic substances.

### Recycling Method

The above objects can also be achieved by the above-described method of recycling a mixed-plastic recycling stream, comprising the steps a) to n), with steps j) to n) being optional. In other words, the recycled polyethylene fraction (rPE) used in the present invention is preferably obtainable or is obtained by the above-described method or preferred methods.

The presence of carbon black has an influence on the density of the virgin polyethylene, as explained above.

### Virgin Polyethylenes (B)/(B1)

As stated above, the mixed-plastic recyclate polyethylene composition of the present invention further comprises at least one virgin polyethylene component (B), optionally blended with carbon black, and optionally a virgin polyethylene component (B1), different from virgin polyethylene component (B), optionally blended with carbon black. The at least one virgin polyethylene component (B) or the virgin polyethylene component (B1) may preferably be a high density or medium density component.

The at least one virgin polyethylene component (B) preferably has a melt flow rate (ISO 1133, 2.16 kg, 190° C.) of from 0.01 to 1.2 g/10 min, more preferably from 0.05 to 1.0 g/10 min, and has a density of from 920 to 970 kg/m³, preferably from 920 to 955 kg/m³ without carbon black or a density of from 932 to 982 kg/m³, preferably from 944 to 967 kg/m³ with carbon black.

The mixed-plastic recyclate polyethylene composition according to the present invention may further preferably comprise a virgin polyethylene component (B1), different from virgin polyethylene component (B), having a melt flow rate (ISO 1133, 2.16 kg, 190° C.) of from 0.04 to 0.8 g/10 min, more preferably from 0.05 to 0.5 g/10 min and may have a density of from 930 to 960 kg/m³, more preferably from 935 to 955 kg/m³ without carbon black, or a density of from 942 to 972 kg/m³, more preferably from 947 to 967 kg/m³ with carbon black.

The at least one virgin polyethylene component (B) and/or the virgin polyethylene component (B1) may preferably comprise at least one bimodal polyethylene and may preferably comprise a polyethylene homopolymer and a polyethylene copolymer. In some cases, the at least one virgin polyethylene component (B) and/or the virgin polyethylene component (B1) may comprise a copolymer of ethylene and one or more comonomer units selected from alpha-olefins having from 3 to 6 carbon atoms. They may comprise a copolymer of ethylene and 1-butene or a copolymer of ethylene and 1-hexene.

In this context the term “bimodal” means herein that the polymer consists of two polyethylene fractions, which have been produced under different polymerisation conditions resulting in different (weight average) molecular weights and molecular weight distributions for the fractions. The form of the molecular weight distribution curve, i.e. the appearance of the graph of the polymer weight fraction as function of its molecular weight, of such a bimodal polyethylene will show two maxima or at least be distinctly broadened in comparison with the curves for the individual fractions.

The bimodal polyethylene preferably comprises a polyethylene homopolymer and a polyethylene copolymer.

By ethylene homopolymer is meant a polymer which is formed of essentially only ethylene monomer units, i.e. of 99.9 wt.-% ethylene or more. It will be appreciated that minor traces of other monomers may be present due to industrial ethylene containing trace amounts of other monomers.

The ethylene copolymer is formed from ethylene with at least one other alpha-olefin comonomer having at least 4 carbon atoms, e.g. C4-20 alpha-olefin. Preferred comonomers are alpha-olefins, especially with 4-8 carbon atoms. Preferably, the comonomer is selected from the group consisting of 1-butene, 1-hexene, 4-methyl-1-pentene, 1-octene, 1,7-octadiene and 7-methyl-1,6-octadiene. The use of 1-butene and/or 1-hexene is preferred.

Processes for obtaining such polymers are well known to a person skilled in the art and described for example in WO 2015/121161 A1.

The at least one virgin polyethylene component (B) may preferably have a complex viscosity at angular frequency ω of 0.05 rad/s (eta_{0.05}) of from 15,000 to 90,000 Pa·s, more preferably from 16,000 Pa·s to 80,000 Pa·s and even more preferably from 17,000 to 70,000 Pa·s; and a shear thinning factor (STF) (eta_{0.05}/eta₃₀₀), defined as the ratio of the complex viscosities eta_{0.05} and eta₃₀₀ at 190° C. within a frequency range of from 0.01 and 600 rad/s according to ISO 6721-1 and 6721-10, determined as described in the experimental section below, in the range of from 20 to 100, more preferably in the range of from 22 to 80, even more preferably in the range of from 25 to 70. The shear thinning factor (STF) indicates the processability of the polyethylene material.

The virgin polyethylene component (B1) may preferably have a complex viscosity at angular frequency ω of 0.05 rad/s (eta_{0.05}) of from 100,000 Pa·s to 280,000 Pa·s, preferably from 120,000 Pa·s to 250,000 Pa·s and more preferably from 140,000 Pa·s to 230,000 Pa·s; and a shear thinning factor (STF) (eta_{0.05}/eta₃₀₀), defined as the ratio of the complex viscosities eta_{0.05} and eta₃₀₀ at 190° C. within a frequency range of from 0.01 and 600 rad/s according to ISO 6721-1 and 6721-10, determined as described in the experimental section below, in the range of from 50 to 300, more preferably in the range of from 60 to 280, even more preferably in the range of from 80 to 250.

The at least one virgin polyethylene component (B) may preferably have a strain hardening modulus of from 12 to 49 MPa, more preferably from 14 to 45 MPa, most preferably from 15 to 42 MPa.

The virgin polyethylene component (B1) may preferably have a strain hardening modulus of from 40 to 130 MPa, more preferably from 50 to 120 MPa, most preferably from 70 to 110 MPa.

Strain hardening modulus reflects slow crack growth resistance (Kurelec, L., Teeuwen, M., Schoffeleers, H. & Deblieck, R. Strain hardening modulus as a measure of environmental stress crack resistance (ESCR) of high density polyethylene. Polymer 46, 6369-6379, (2005)). Thus, the increased strain hardening modulus of the virgin polyethylene components (B) and/or (B1) contribute to an improvement of the slow crack growth resistance of the final recyclate polyethylene compositions of the invention.

As described above, the mixed-plastic recyclate polyethylene composition of the present invention exhibits an environmental stress crack resistance (ESCR) according to the Bell test, in accordance with IEC 60811-406, method B and as described in the experimental section below, of at least 1000 h failure time, preferably at least 2500 h failure time. The mixed-plastic recyclate polyethylene composition of the present invention may preferably exhibit an ESCR of not more than 20,000 h failure time.

It is preferred that the mixed-plastic recyclate polyethylene composition according to the present invention comprises at least 20.0 wt.-%, more preferably at least 25 wt.-%, even more preferably at least 30 wt.-% of the total amount of the virgin polyethylene components defined above. Preferably, the mixed-plastic recyclate polyethylene composition according to the present invention comprises not more than 60.0 wt.-%, more preferably not more than 55 wt.-%, even more preferably not more than 50 wt.-% of the total amount of the virgin polyethylene components defined above.

The mixed-plastic recyclate polyethylene composition according to the present invention may comprise, in some embodiments, not more than 70 wt.-% of the recycled polyethylene fraction (rPE) as defined above, and said at least one virgin polyethylene component (B) and/or said virgin high density polyethylene component (B1) having a density (ISO 1183) of not more than 942 kg/m³. Such compositions surprisingly show improvement of stress and strain at break, impact strength and ESCR, as in inventive examples IE4 to IE8, given in the experimental section.

### Article

The present invention further relates to an article, preferably being a jacketing material of a power or optical cable made from the mixed-plastic recyclate polyethylene composition according to the present invention, whereby said mixed-plastic recyclate polyethylene composition amounts to at least 85 wt.-%, preferably at least 88 wt.-%, more preferably at least 90 wt.-% of the total composition for making the article.

### Use

The present invention further relates to the use of the mixed-plastic recyclate polyethylene composition according to the present invention for wire and cable applications.

The mixed-plastic recyclate polyethylene composition according to the present invention is characterized by a higher purity in terms of isolated and continuous C3 units, improved ESCR (Bell test) performance, higher strain/stress at break performance, higher tear resistance, high Charpy notched impact strength (NIS), high tensile modulus and improved strain hardening modulus as well as lower white spot rating than recyclate polyethylene composition that comprise conventional PCR fractions. Details are discussed in the example section below.

### Measurement Methods

The following definitions of terms and determination methods apply to the above general description of the invention as well as to the below examples, unless otherwise defined.

### a) Melt Flow Rate

The melt flow rate (MFR) was determined according to ISO 1133 and is indicated in g/10 min. The MFR is an indication of the flowability and hence the processability of the polymer. The higher the melt flow rate, the lower the viscosity of the polymer. Here, the MFR was determined at a temperature of 190° C. and under a load of 2.16 kg, 5.0 kg or 21.6 kg.

### b) Density

For determining the density of non-cellular plastics the ISO 1183-1:2012 Standard method A immersion method is used (Archimedean principle). A specimen is weighed in air and immersed in a liquid (Isododecane), whose density is lower than that of the specimen. The value of this force is the same as that of the weight of the liquid displaced by the volume of the specimen.

This test is done on compression moulded plates of PE (polyethylene). For compression moulding process the following parameters are used.

Pressure

| | Time | Temperature | Hydraulic | Mould |
|---|---|---|---|---|
| PE | [s] | [° C.] | [bar] | [N/cm²] |
| Preheating | 360 | 180 | 5 | 7 |
| Moulding | 300 | 180 | 50 | 65 |
| | 300 | 180 | 200 | 262 |
| | 840 | 23 | | |

| | | | |
|---|---|---|---|
| Cooling | 15 K/min | 200 | 262 |
| | <40° C. demoulding | | |
| | temperature | | |

Conditioning time: 24 h after compression moulding (PE)
Test temperature: 23° C.
Immersion liquid: Isododecane
Buoyancy correction: no

### c) C2 Fraction by NMR Spectroscopy and General Microstructure Including “Continuous C3” as Well as Short Chain Branches

Quantitative ¹³C{¹H} NMR spectra were recorded in the solution-state using a Bruker Avancelll 400 MHz NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent {singh09}. To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme {zhou07,busico07}. A total of 6144 (6 k) transients were acquired per spectra.

Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. Characteristic signals corresponding to polyethylene with different short chain branches (B1, B2, B4, B5, B6plus) and polypropylene were observed {randall89, brandolini00}.

Characteristic signals corresponding to the presence of polyethylene containing isolated B1 branches (starB1 33.3 ppm), isolated B2 branches (starB2 39.8 ppm), isolated B4 branches (twoB4 23.4 ppm), isolated B5 branches (threeB5 32.8 ppm), all branches longer than 4 carbons (starB4plus 38.3 ppm) and the third carbon from a saturated aliphatic chain end (3 s 32.2 ppm) were observed. The intensity of the combined ethylene backbone methine carbons (ddg) containing the polyethylene backbone carbons (dd 30.0 ppm), γ-carbons (g 29.6 ppm) the 4 s and the threeB4 carbon (to be compensated for later on) is taken between 30.9 ppm and 29.3 ppm excluding the TPP from polypropylene. The amount of C2 related carbons was quantified using all mentioned signals according to the following equation:

$${fC}_{C 2 total} = ( Iddg - ItwoB 4 ) + ( IstarB 1 * 6 ) + ( IstarB 2 * 7 ) + ( ItwoB 4 * 9 ) + I ( threeB 5 * 10 ) + ( ( IstarB 4 plus - ItwoB 4 - IthreeB 5 ) * 7 ) + ( I 3 s * 3 )$$

Characteristic signals corresponding to the presence of polypropylene (PP, continuous C3)) were observed at 46.7 ppm, 29.0 ppm and 22.0 ppm. The amount of PP related carbons was quantified using the integral of Sαα at 46.6 ppm:

$${fC}_{PP} = Is αα * 3$$

The weight percent of the C2 fraction and the polypropylene can be quantified according following equations:

$${wt}_{C 2 fraction} = {fC}_{C 2 total} * 100 / ( {fC}_{C 2 total} + {fC}_{PP} )$$

$${wt}_{PP} = {fC}_{pp} * 100 / ( {fC}_{C 2 total} + {fC}_{PP} )$$

Characteristic signals corresponding to various short chain branches were observed and their weight percentages quantified as the related branch would be an alpha-olefin, starting by quantifying the weight fraction of each:

$$fwtC 2 = {fC}_{C 2 total} - ( ( IstarB 1 * 3 ) - ( IstarB 2 * 4 ) - ( ItwoB 4 * 6 ) - ( IthreeB 5 * 7 )$$

$$fwtC 3 ( isolated C 3 ) = IstarB 1 * 3$$

$$fwtC 4 = IstarB 2 * 4$$

$$fwtC 6 = ItwoB 4 * 6$$

$$fwtC t = IthreeB 5 * 7$$

Normalisation of all weight fractions leads to the amount of weight percent for all related branches:

$${fsum}_{wt \% total} = fwC 2 + fwtC 3 + fwtC 4 + fwtC 6 + fwtC 7 + {fC}_{PP}$$

$$wtC 2 total = fwtC {2}^{*} 100 / {fsum}_{wt \% total}$$

$$wtC 3 total = fwtC {3}^{*} 100 / {fsum}_{wt \% total}$$

$$wtC 4 total = fwtC {4}^{*} 100 / {fsum}_{wt \% total}$$

$$wtC 6 total = fwtC {6}^{*} 100 / {fsum}_{wt \% total}$$

$$wtC 7 total = fwtC {7}^{*} 100 / {fsum}_{wt \% total}$$

The content of LDPE can be estimated assuming the B5 branch, which only arises from ethylene being polymerised under high pressure process, being almost constant in LDPE. We found the average amount of B5 if quantified as C7 at 1.46 wt %. With this assumption it is possible to estimate the LDPE content within certain ranges (approximately between 20 wt % and 80 wt %), which are depending on the SNR ratio of the threeB5 signal:

$$wt \% LDPE = wtC 7 total * 100 / 1.46$$

### REFERENCES

zhou07 Zhou, Z., Kuemmerle, R., Qiu, X., Redwine, D., Cong, R., Taha, A., Baugh, D. Winniford, B., J. Mag. Reson. 187 (2007) 225
busico07 Busico, V., Carbonniere, P., Cipullo, R., Pellecchia, R., Severn, J., Talarico, G., Macromol. Rapid Commun. 2007, 28, 1128
singh09 Singh, G., Kothari, A., Gupta, V., Polymer Testing 28 5 (2009), 475
randall89 J. Randall, Macromol. Sci., Rev. Macromol. Chem. Phys. 1989, C29, 201.
brandolini00 A. J. Brandolini, D. D. Hills, NMR Spectra of Polymers and Polymer Additives, Marcel Dekker Inc., 2000

### d) Cross Fractionation Chromatography

The chemical composition distribution as well as the determination of the molecular weight distribution and the corresponded molecular weight averages (Mn, Mw and Mv) at a certain elution temperature (polymer crystallinity in solution) were determined by a full automated Cross Fractionation Chromatography (CFC) as described by Ortin A., Monrabal B., Sancho-Tello J., Macromol. Symp., 2007, 257, 13-28.

A CFC instrument (PolymerChar, Valencia, Spain) was used to perform the cross-fractionation chromatography (TREF×SEC). A four band IR5 infrared detector (PolymerChar, Valencia, Spain) was used to monitor the concentration. The polymer was dissolved at 160° C. for 150 minutes at a concentration of around 1 mg/ml.

To avoid injecting possible gels and polymers, which do not dissolve in TCB at 160° C., like PET and PA, the weighed out sample was packed into stainless steel mesh MW 0,077/D 0.05 mmm.

Once the sample was completely dissolved an aliquot of 0.5 ml was loaded into the TREF column and stabilized for a while at 110° C. The polymer was crystallized and precipitate to a temperature of 30° C. by applying a constant cooling rate of 0.1° C./min. A discontinuous elution process is performed using the following temperature steps: (35, 40, 50, 55, 60, 65, 70, 75, 80, 85, 90, 95, 100, 103, 106, 109, 112, 115, 117, 119, 121, 123, 125, 127, 130, 135 and 140).

In the second dimension, the GPC analysis, 3 PL Olexis columns and 1× Olexis Guard columns from Agilent (Church Stretton, UK) were used as stationary phase. As eluent 1,2,4-trichlorobenzene (TCB, stabilized with 250 mg/L 2,6-Di tert butyl-4-methyl-phenol) at 150° C. and a constant flow rate of 1 mL/min were applied. The column set was calibrated using universal calibration (according to ISO 16014-2:2003) with at least 15 narrow MWD polystyrene (PS) standards in the range of 0.5 kg/mol to 11 500 kg/mol. Following Mark Houwink constants were used to convert PS molecular weights into the PP molecular weight equivalents.

$${K}_{PS} = 19 \times {10}^{- 3} mL / g , {α}_{PS} = 0.65$$

$${K}_{PS} = 19 \times {10}^{- 3} mL / g , {α}_{PP} = 0.725$$

A third order polynomial fit was used to fit the calibration data. Data processing was performed using the software provided from PolymerChar with the CFC instrument.

### e) Environmental Stress Cracking Resistance (Bell Test)

By the term ESCR (environmental stress cracking resistance) is meant the resistance of the polymer to crack formation under the action of mechanical stress and a reagent in the form of a surfactant. The ESCR was determined in accordance with IEC 60811-406, method B. The reagent employed was 10 weight % Igepal CO 630 in water. The materials were prepared according to instructions for HDPE as follows: The materials were pressed at 165° C. to a thickness of 1.75-2.00 mm. The notch was 0.30-0.40 mm deep. In the results, a value of “0” means that the sample failed during preparation.

### f) Tensile Testing

Dog bone specimens of 5 A were prepared according to ISO 527-2/5 A by die cutting from compression moulded plaques of 2 mm′ thickness. All specimens were conditioned for at least 16 hours at 23° C. and 50% relative humidity before testing. Tensile properties were measured according to ISO 527-1/2 at 23° C. and 50% relative humidity with Alwetron R24, 1 kN load cell. Tensile testing speed was 50 mm/min, grip distance was 50 mm and gauge length was 20 mm. 5 A Specimen were tested before and after ageing of 5 A specimen at 100° C., after 10 days (240 h) or at 110° C. after 14 days (336 h).

### g) Flexural Modulus

The flexural modulus was determined according to ISO 178 method A (3-point bending test) on 80 mm×10 mm×4 mm. Following the standard, a test speed of 2 mm/min and a span length of 16× thickness was used. The testing temperature was 23±2° C. Compression moulding was carried out according to ISO 17855-2.

### h) Impact Strength (Charpy NIS)

Charpy notched impact strength (NIS) was determined according to ISO 179-1/1 eA on notched specimen of 80 mm×10 mm×4 mm (compression moulded specimen according to ISO 179-1/1 eA). Testing temperature was 0±2° C., −20±2° C. or −30±2° C. Compression moulding was carried out according to ISO 17855-2.

### i) CIELAB Color Space (L*a*b*)

Color values and color difference were determined according to ISO 11664-4.

In the CIE L*a*b* uniform color space, the color coordinates are: L*—the lightness coordinate; a*—the red/green coordinate, with +a* indicating red, and −a* indicating green; and b*—the yellow/blue coordinate, with +b* indicating yellow, and −b* indicating blue. The L*, a*, and b*coordinate axis define the three dimensional CIE color space. Standard Konica/Minolta Colorimeter CM-3700A was used for measurement.

### j) Heavy Metal Content

The content of heavy metals including Cr, Cd, Hg, and Pb was determined by x ray fluorescence (XRF).

The instrument used for the XRF measurements was a wavelength dispersive Zetium (2.4 kW) from Malvern Panalytical. The instrument was calibrated with polyolefin based standard sets from Malvern Panalytical i.e. Toxel.

The analysis are done under vacuum on a plaque with a diameter of 40 mm and a thickness of 2 mm.

The method is used to determine the quantitative content of Cr, Cd, Hg and Pb in polyolefin matrix within defined ranges of this standard.

### k) Strain Hardening (SH) Modulus

The strain hardening test is a modified tensile test performed at 80° C. on a specially prepared thin sample. The Strain Hardening Modulus (MPa), <Gp>, is calculated from True Strain-True Stress curves; by using the slope of the curve in the region of True Strain, λ, is between 8 and 12.

The true strain, λ, is calculated from the length, l (mm), and the gauge length, l0 (mm), as shown by Equation 1.

$$λ = \frac{I}{{I}_{0}} = 1 + \frac{Δ I}{{I}_{0}} \qquad ( 1 )$$

where Δl is the increase in the specimen length between the gauge marks, (mm). The true stress, σtrue (MPa), is calculated according to formula 2, assuming conservation of volume between the gauge marks:

$${σ}_{true} = {σ}_{n} λ \qquad ( 2 )$$

where an is the engineering stress.

The Neo-Hookean constitutive model (Equation 3) is used to fit the true strain-true stress data from which <Gp> (MPa) for 8<λ<12 is calculated.

$${σ}_{true} = \frac{〈 Gp 〉}{20} ( {λ}^{2} - \frac{1}{λ} ) + C \qquad ( 3 )$$

where C is a mathematical parameter of the constitutive model describing the yield stress extrapolated to λ=0.

Initially five specimens were measured. If the variation coefficient of <Gp> was greater than 2.5%, then two extra specimens were measured. In case straining of the test bar takes place in the clamps the test result is discarded.

The PE granules of materials were compression moulded in sheets of 0.30 mm thickness according to the press parameters as provided in ISO 1872-2, Table 2.

After compression moulding of the sheets, the sheets were annealed to remove any orientation or thermal history and maintain isotropic sheets. Annealing of the sheets was performed for 1 h in an oven at a temperature of (120±2) ° C. followed by slowly cooling down to room temperature by switching off the temperature chamber. During this operation free movement of the sheets was allowed.

Next, the test pieces were punched from the pressed sheets. The specimen geometry of the modified ISO 37:1994 Type 3 (FIG. 3) was used.

The sample has a large clamping area to prevent grip slip, dimensions given in Table 1.

TABLE 1
Dimensions of Modified ISO 37:1994 Type 3

| Dimension | | Size (mm) |
|---|---|---|
| L | start length between clamps | 30.0 +/− 0.5 |
| I0 | Gauge length | 12.5 +/− 0.1 |
| I1 | Prismatic length | 16.0 +/− 1.0 |
| I3 | Total length | 70 |
| R1 | Radius | 10.0 +/− 0.03 |
| R2 | Radius | 8.06 +/− 0.03 |
| b1 | Prismatic width | 4.0 +/− 0.01 |
| b2 | Clamp width | 20.0 +/− 1.0 |
| h | Thickness | 0.30 + 0.05/ |
| | | 0.30 − 0.03 |

The punching procedure is carried out in such a way that no deformation, crazes or other irregularities are present in the test pieces.

The thickness of the samples was measured at three points of the parallel area of the specimen; the lowest measured value of the thickness of these measurements was used for data treatment.
1. The following procedure is performed on a universal tensile testing machine having controlled temperature chamber and non-contact extensometer:
2. Condition the test specimens for at least 30 min in the temperature chamber at a temperature of (80±1) ° C. prior to starting the test.
3. Clamp the test piece on the upper side.
4. Close the temperature chamber.
5. Close the lower clamp after reaching the temperature of (80±1) ° C.
6. Equilibrate the sample for 1 min between the clamps, before the load is applied and measurement starts.
7. Add a pre-load of 0.5 N at a speed of 5 mm/min.
8. Extend the test specimen along its major axis at a constant traverse speed (20 mm/min) until the sample breaks.
   During the test, the load sustained by the specimen is measured with a load cell of 200 N. The elongation is measured with a non-contact extensometer.

### l) Carbon Black Dispersion and White Spot Rating

Measurements have been performed according to ISO 18553. Slices with thickness of approx. 15 μm were microtomed from six pellets with a Leica Histocore NANOCUT R and fixed to glass slides. These were examined with a Microscope Olympus BX51 in transmission light, with magnification of 100×, collecting and stiching together images from each whole section. Particles were automatically detected by the Olympus software Particle Inspector on each section. Classes to provide the final grading were taken from ISO 18553 (e.g., grade 1 being either 1 particle with diameter of 11-20 μm or 3 particles with diameter 5-10 μm), for both carbon black agglomerations but also for white spots. The final result is the average of the six single measurements (slices).

### m) Tear Resistance

Tear resistance was measured on compression moulded plaques of 1 mm thickness according to BS 6469 section 99.1. A test piece with a cut was used to measure the tear force by means of a tensile testing machine. The tear resistance is calculated by dividing the maximum force needed to tear the specimen by its thickness.

### n) Dynamic Rheological Measurements

The characterisation of polymer melts by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. for PE, applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$( t ) = {γ}_{0} sin ( ω t ) \qquad ( 1 )$$

If the applied strain is within the linear viscoelastic regime, the resulting sinusoidal stress response can be given by

$$( t ) = {σ}_{0} sin ( ω t + δ ) \qquad ( 2 )$$

where
σ₀ and γ₀ are the stress and strain amplitudes, respectively
ω is the angular frequency
δ is the phase shift (loss angle between applied strain and stress response)
t is the time.

Dynamic test results are typically expressed by means of several different rheological functions, namely the shear storage modulus G′, the shear loss modulus, G″, the complex shear modulus, G*, the complex shear viscosity, η*, the dynamic shear viscosity, η′, the out-of-phase component of the complex shear viscosity η″ and the loss tangent, tan δ which can be expressed as follows:

$${G}^{′} = \frac{{σ}_{0}}{{γ}_{0}} cos δ [ Pa ] \qquad ( 3 )$$

$${G}^{′} = \frac{{σ}_{0}}{{γ}_{0}} sinδ [ Pa ] \qquad ( 4 )$$

$$G *= {G}^{′} + {iG}^{″} [ Pa ] \qquad ( 5 )$$

$$η *= {η}^{′} - {i η}^{″} [ Pa . s ] \qquad ( 6 )$$

$${η}^{′} = \frac{{G}^{″}}{ω} [ Pa . s ] \qquad ( 7 )$$

$${η}^{″} = \frac{{G}^{′}}{ω} [ Pa . s ] \qquad ( 8 )$$

The determination of so-called Shear Thinning Factor (STF) is done, as described in equation 9.

$$STF = \frac{Eta * for ( ω = 0.05 rad / s )}{Eta * for ( ω = 300 rad / s )} \qquad ( 9 )$$

The values are determined by means of a single point interpolation procedure, as defined by Rheoplus software. In situations for which a given G* value is not experimentally reached, the value is 10 determined by means of an extrapolation, using the same procedure as before. In both cases (interpolation or extrapolation), the option from Rheoplus “-Interpolate y-values to x-values from parameter” and the “logarithmic interpolation type” were applied.

These tests were done on compression moulded discs.

### o) LAOS Non-Linear Viscoelastic Ratio

The investigation of the non-linear viscoelastic behaviour under shear flow was done resorting to Large Amplitude Oscillatory Shear. The method requires the application of a sinusoidal strain amplitude, γ₀, imposed at a given angular frequency, ω, for a given time, t. Provided that the applied sinusoidal strain is high enough, a non-linear response is generated. The stress, σ, is in this case a function of the applied strain amplitude, time and the angular frequency. Under these conditions, the non-linear stress response is still a periodic function, however, it can no longer be expressed by a single harmonic sinusoid. The stress resulting from linear viscoelastic response [1-3] can be expressed by a Fourier series, which includes higher harmonics contributions:

$$σ ( t , ω , {γ}_{0} ) = {γ}_{0} \cdot {\sum }_{n} [ {G}_{n}^{′} ( ω , {γ}_{0} ) \cdot sin ( n ω t ) + {G}_{n}^{″} ( ω , {γ}_{0} ) \cdot cos ( n ω t ) ]$$

with σ=stress response
   t=time
   ω=frequency
   γ₀=strain amplitude
   n=harmonic number
   G′ₙ=n order elastic Fourier coefficient
   G″ₙ=n order viscous Fourier coefficient

The non-linear viscoelastic response was analysed applying Large Amplitude Oscillatory Shear (LAOS). Time sweep measurements were undertaken on an RPA 2000 rheometer from Alpha Technologies coupled with a standard biconical die. During the course of the measurement the test chamber is sealed and a pressure of about 6 MPa is applied. The LAOS test is done applying a temperature of 190° C., an angular frequency of 0.628 rad/s and a strain of 1000% (LAOS_{NLF} (1000%)). In order to ensure that steady state conditions are reached, the non-linear response is only determined after at least 20 cycles per measurement are completed. The Large Amplitude Oscillatory Shear Non-Linear Factor (LAOS_{NLF}) is defined by:

$${LAOS}_{NLF} ( X \% ) = \vert \frac{{G}_{1}^{′}}{{G}_{3}^{′}} \vert$$

with G′₁=first order elastic Fourier coefficient
   G′₃=third order elastic Fourier coefficient

### REFERENCES

1. J. M. Dealy, K. F. Wissbrun, Melt Rheology and Its Role in Plastics Processing: Theory and Applications; edited by Van Nostrand Reinhold, New York (1990);
2. S. Filipe, Non-Linear Rheology of Polymer Melts, AIP Conference Proceedings 1152, pp. 168-174 (2009) 3;
3. M. Wilhelm, Macromol. Mat. Eng. 287, 83-105 (2002);
4. S. Filipe, K. Hofstadler, K. Klimke, A. T. Tran, Non-Linear Rheological Parameters for Characterisation of Molecular Structural Properties in Polyolefins, Proceedings of Annual European Rheology Conference, 135 (2010);
5. S. Filipe, K. Klimke, A. T. Tran, J. Reussner, High Throughput Experimentation: Novel Non-Linear Rheological Parameters for Quality Control, Novel Trends in Rheology IV, Zlin, Czech Republic (2011);
6. K. Klimke, S. Filipe, A. T. Tran, Non-linear rheological parameters for characterization of molecular structural properties in polyolefins, Proceedings of European Polymer Conference, Granada, Spain (2011).

### p) Antioxidant Content

Antioxidant content (chemicals like Irganox® 1010 (pentaerythrityl-tetrakis(3-(3′,5′-di-tert. butyl-4-hydroxyphenyl)-propionate)) and Irgfos® 168 (tris (2,4-di-t-butylphenyl) phosphite)) was determined via high performance liquid chromatography (HPLC) after extraction with ethyl acetate. Therefore, about 10 g of the sample were cryo-milled with the aid of liquid nitrogen. After that, a portion of approximately 0.5 g of the milled sample was extracted using ethyl acetate as a solvent. Extraction was performed at 95° C. for 90 min under constant stirring. After letting the mixture cool down to room temperature again it was filtered and put to the HPLC test for the quantification of antioxidants. The HPLC system was equipped with a C18 column for the separation and a diode array detector (DAD) for detection.

### q) Oxidation Induction Time OIT

The oxidation induction time (OIT) at 200° C. was determined with a TA Instrument Q20 according to ISO11357-6. Calibration of the instrument was performed with Indium and Tin, according to ISO 11357-1. The maximum error in temperature from calibration was less than 0.1 K. Each polymer sample (cylindrical geometry with a diameter of 5 mm and thickness of 1±0.1 mm) with a weight of 10±2 mg was placed in an open aluminium crucible, heated from 25° C. to 200° C. at a rate of 20° C. min⁻¹ in nitrogen (>99.95 vol. % N₂, <5 ppm 02) with a gas flow rate of 50 mL min⁻¹, and allowed to rest for 5 min before the atmosphere was switched to pure oxygen (>99.95 vol. % O₂), also at a flow rate of 50 mL min⁻¹. The samples were maintained at constant temperature, and the exothermal heat associated with oxidation was recorded. The oxidation induction time was the time interval between the initiation of oxygen flow and the onset of the oxidative reaction. Each presented data point was the average of two independent measurements.

### r) Water Content

The water content was determined as described in ISO15512:2019 Method A—Extraction with anhydrous methanol. There the test portion is extracted with anhydrous methanol and the extracted water is determined by a coulometric Karl Fischer Titrator.

### s) Shore D Hardness

Shore D hardness was determined according to ISO 868 on compression moulded specimen with a thickness of 4 mm. The shore hardness was determined after 1 s, 3 s or 15 s after the pressure foot was in firm contact with the test specimen. The sample was compression moulded according to ISO 17855-2 and milled into specimens of 80×10×4 mm.

### t) Cable Extrusion

The cable extrusion was done on a Nokia-Maillefer cable line. The extruder has five temperature zones with temperatures of 170/175/180/190/190° C. and the extruder head has three zones with temperatures of 210/210/210° C. The extruder screw is a barrier screw of the design Elise. The die is a semi-tube on type with 5.9 mm diameter and the outer diameter of the cable is 5 mm. The compound was extruded on a 3 mm in diameter, solid aluminum conductor to investigate the extrusion properties. Line speed is 75 m/min. The pressure at the screen and the current consumption of the extruder was recorded for each material.

### u) Cable Shrinkage

The shrinkage of the composition was determined with the cable samples obtained from the cable extrusion. The cables were conditioned in the constant room at least 24 hours before the cutting of the samples. The conditions in the constant room were 23±2° C. and 50±5% humidity. Samples were cut to 400 mm at least 2 m away from the cable ends. They were further conditioned in the constant room for 24 hours after which they were placed in an oven on a talcum bed at 100° C. for 24 hours. After removal of the sample from the oven they were allowed to cool down to room temperature and then measured. The shrinkage is calculated according to formula below:

$$[ ( L Before - L After ) / L Before ] \times 100 \% ,$$

wherein L is length.

### v) Gel Count (OCS)

The cast film samples of the recycled polyethylene fractions have been produced and optically examined on a small-scale laboratory cast film line with installed camera detection from Optical Control Systems GmbH.

The line consists of an extruder with a Ø 25 mm screw with an L/D ration of 25. The extruder temperature profile has been set at 190/200/210/210/200° C. for the five zones. The screw speed was 30 rpm. The extruder is followed by a die with a width of 150 mm and a fixed die gap of 0.5 mm. The film has been produced with a thickness of 70 μm. During the extrusion the chill-roll temperature has been set at 50° C. The gels and contaminations of the film have been detected and counted on 10 m² of the film during the extrusion process with transmitted light and a 4096 pixel camera. The resolution of the camera is 25 μm×25 on film. The gels and contaminations have been divided into 4 size-classes (100-299 μm; 300-599 μm; 600-1000 μm; >1000 μm).

### w) Crystallization and Melting Temperature (Tc and Tm)

A TA Instruments 02000 Differential Scanning Calorimeter calibrated with indium, zinc, and tin and operating under 50 mL/min of nitrogen flow was used. The employed thermal program consisted of a first heating step from 0 to 180° C. to erase the previous thermal history and a cooling step at 10° C./min. The melting behavior was obtained by performing a second heating scan from 0 to 180° C. at 10° C./min. The crystallization and melting temperatures were taken as the peak values from the cooling and second heating scan respectively.

### x) Thermogravimetric Analysis (TGA)

x-1) Measurement of Carbon Black Content by TGA

Thermogravimetric Analysis (TGA) experiments were performed with a Perkin Elmer TGA 8000. Approximately 10-20 mg of materials were placed in a platinum pan. The temperature was equilibrated at 50° C. for 10 minutes, and afterwards raised to 900° C. under nitrogen at 20° C./min. Afterwards the temperature was lowered to 300° C. at 20° C./min, gas switched to oxygen, and the temperature was raised again to 900° C. The weight loss in this final step was assigned to carbon black.

x-2) Measurement of Ash Content by TGA

Inorganic residues were measured by TGA according to DIN ISO 1172:1996 using a Perkin Elmer TGA 8000. Approximately 10-20 mg of material was placed in a platinum pan. The temperature was equilibrated at 50° C. for 10 minutes, and afterwards raised to 950° C. under nitrogen at a heating rate of 20° C./min. The ash content was evaluated as the weight % at 850° C.

### y) Odor (VDA270-B3)

VDA 270 is a determination of the odor characteristics of trim materials in motor vehicles. In this study, the odor is determined following VDA 270 (2018) variant B3. The odor of the respective sample is evaluated by each assessor according to the VDA 270 scale after lifting the jar's lid as little as possible. The hexamerous scale consists of the following grades: Grade 1: not perceptible, Grade 2: perceptible, not disturbing, Grade 3: clearly perceptible, but not disturbing, Grade 4: disturbing, Grade 5: strongly disturbing, Grade 6: not acceptable. Assessors stay calm during the assessment and are not allowed to bias each other by discussing individual results during the test. They are not allowed to adjust their assessment after testing another sample, either. For statistical reasons (and as accepted by the VDA 270) assessors are forced to use whole steps in their evaluation. Consequently, the odor grade is based on the average mean of all individual assessments, and rounded to whole numbers.

### z) Headspace Gas Chromatography/Mass Spectroscopy (HS-GC-MS)

The determination of benzene and limonene is based on a static headspace (HS) approach. This analysis uses a combination of a HS sampler with a gas chromatograph (GC) and a mass spectrometer (MS) for screening purposes.

Samples were delivered to the lab in sealed aluminum-coated polyethylene (PE) bags. Prior to the analysis, samples were cryo-milled, a portion of 2.000±0.100 g was weighed in a 20 ml HS vial and tightly closed. For every sample, a double determination was performed.

### 1.1 HS/GC/MS Parameters

HS parameters (Agilent G1888 Headspace Sampler)
Vial equilibration time: 120 min (sample), 5 min (standard)
Oven temperature: 100° C. (sample), 200° C. (standard)
Loop temperature: 110° C. (sample), 205° C. (standard)
Transfer line temperature: 120° C. (sample), 210° C. (standard)
Low shaking

### GC Parameters (Agilent 7890A GC System)

Column: ZB-WAX 7HG-G007-22 (30 m×250 μm×1 μm)
Carrier gas: Helium 5.0
Flow: 2 ml/min
Split: 5:1
GC oven program: 35° C. for 0.1 min
   10° C./min until 250° C.
   250° C. for 1 min
      MS Parameters (Agilent 5975C inert XL MSD)
Acquisition mode: Scan
Scan parameters:
Low mass: 20
High mass: 200
Threshold: 10

### Software/Data Evaluation

MSD ChemStation E.02.02.1431
MassHunter GC/MS Acquisition B.07.05.2479
AMDIS GC/MS Analysis Version 2.71
NIST/EPA/NIH Mass Spectral Library (2011 version)
NIST Mass Spectral Search Program Version 2.0 g

### AMDIS Deconvolution Parameters

Minimum match factor: 80
Threshold: Low
Scan direction: High to Low
Data file format: Agilent files
Instrument type: Quadrupole
Component width: 20
Adjacent peak subtraction: Two
Resolution: High
Sensitivity: Very high
Shape requirements: Medium
Solvent tailing: 91 m/z
Column bleed: 207 m/z
Min. model peaks: 2
Min. S/N: 10
Min. certain peaks: 0.5

### MSD ChemStation Integration Parameters

Integrator: ChemStation
Initial area reject: 0
Initial peak width: 0.005
Shoulder detection: off
Initial threshold: 10.5

In this study, the statement “below the limit of detection (<LOD)” describes a condition where either the match factor is below 80 (AMDIS) or the signal to noise ratio (Pk-pk S/N=Corrected signal/Pk-pk noise, MSD ChemStation signal to noise report) of the peak in the sample run is below 3. The results refer solely to the measured samples, time of measurement and the applied parameters.

### 1.2. Standard Solutions

For a positive identification and comparison with the (lowest) odor detection thresholds (ODT), a benzene standard and a limonene standard were used, respectively (see Table 1).

For the HS/GC/MS analysis, 5 μl of the respective standard were injected in a 20 ml HS vial, tightly closed and measured.

Assuming full vaporisation of the standard substance, the concentration of benzene (or in the other case limonene) in the HS_{C}_{_{G}} was estimated as listed in the following table.

### Calibration Standard and ODT

| | | c_{G}/mg | Target | (lowest) ODT/ |
|---|---|---|---|---|
| Analyte | Solvent | m⁻³ | ion (m/z) | mg m⁻³ [1] |
| Benzene | Methanol | 25 | 78 | 1.5 |
| Limonene | 2-Butanol | 75 | 68 | 0.21 |

### 1.3 Data Evaluation

The concentration of an analyte in the HS c_{G} is calculated by considering the substance amount m_{G} and the available HS volume V_{G} (Equation 1).

$${c}_{G}^{Standard} [ mg / {m}^{3} ] = \frac{{m}_{G}^{Standard}}{{V}_{G}^{Standard}} \qquad Equation 1$$

To estimate the concentration of an analyte in the HS above a polymer sample, the response factor, Rf of a one-point calibration is required (Equation 2). By integrating the extracted ion chromatogram (EIC), the peak area is obtained for the analyte. The corresponding target ion is listed in

$$Rf = \frac{{c}_{G}^{Standard}}{Peak {area}^{Standard}} \qquad Equation 2$$

The concentration of an analyte in the HS above a polymer sample,

$${c}_{G}^{Sample}$$

is calculated by multiplying the response factor with the EIC peak area of the sample (Equation 3).

$${c}_{G}^{Sample} [ mg / {m}^{3} ] = Rf * Peak {area}^{Sample} \qquad Equation 3$$

Additionally, the odor relevance of an analyte in the HS above a polymer sample is estimated by the odor activity value (OA. Therefore, the concentration of an analyte in the HS above a polymer sample

$${c}_{G}^{Sample}$$

is compared with the (lowest) odor detection threshold (ODT) found in literature (Equation 4) [1]. A value above 1 indicates the relevance of an analyte to the odor at the given HS temperature.

$$OAV = \frac{{c}_{G}^{Sample} [ mg / {m}^{3} ]}{ODT [ mg / {m}^{3} ]} \qquad Equation 4$$

### 1.4 Considerations and Limitations

It must be considered that the ODT for some substances is below the detection limit (LOD) of the method. Therefore, components below the LOD might be missed although still relevant to the overall odor.

The OAV is based on the assumption that the HS parameters are somewhat relatable to the measurement conditions of an ODT determination. Of course, this is not fully applicable because temperature settings of 100° C. are not necessarily chosen for such experiments and have therefore limited practical value. Nevertheless, this approach can at least indicate the odor relevance of the defined marker substances.

Considering all the mentioned assumptions and limitations, the determined concentrations in the HS above the sample and odor activity values must be taken as rough estimates only.

### 1.5 References

[1] Van Gemert L. J., Odor Thresholds: Compilations of odor threshold values in air, water and other media, Utrecht, Oliemans Punter & Partners BV, 2011.

### EXAMPLES

The following polyethylene materials were used for preparing the recyclate compositions examined below:

Recyclate Polyethylene Fractions (rPE)

The feedstock material of rPE1 was obtained from a mixed-plastic fraction sorted out from municipal solid waste (MSW) from Greece and Poland. The feedstock material of rPE2 was obtained mainly from separate plastic waste collection.

rPE1 and rPE2 were produced from the above post-consumer waste feedstocks by a recycling method described below. Each of the feedstocks for rPE1 and rPE2 were subjected separately to a recycling method comprising the following steps:
a) providing post-consumer plastic waste feedstock in bales;
b) screening the material to remove undersize fraction (and, if necessary, oversize fraction),
c) sorting out the HDPE natural and mixed color fraction by near infrared (NIR) and optical sensors.
d) subjecting the HDPE natural and mixed color fractions to milling, washing in an alkaline aqueous solution with various detergents and subsequent drying, windsifting and screening. The resulted HDPE mix color flake is processed further in e) and f) to obtain rPE1; whereas the resulted HDPE natural flake is processed further in e) and f) to obtain rPE2
e) subjecting the resulted plastic flake material to a further sorting for eliminating non-polyolefin flakes;
f) extruding the material in presence of stabilizers and yielding the HDPE blend according to the present invention in the form of pellets;

For comparative purposes a commercial product of HDPE recyclate (rPE3) was provided. It is based on feedstock of post-consumer waste (PCW) mainly comprising pre-sorted community waste.

Recycled Polyethylene Fraction rPE1

rPE1 has a density of 961.5 kg/m³, a MFR₂ of 0.39 g/10 min, a MFR₅ of 1.69 g/10 min and an amount of continuous C3 units (PP) of 1.45 wt.-%, determined by quantitative ¹³C{1H}-NMR measurement of the soluble fraction.

Recycled Polyethylene Fraction rPE2

rPE2 has a density of 958.1 kg/m³, a MFR₂ of 0.55 g/10 min, a MFR₅ of 1.38 g/10 min and an amount of continuous C3 units (PP) of 0.1 wt.-%, determined by quantitative ¹³C{1H}-NMR measurement of the soluble fraction.

Recycled Polyethylene Fraction rPE3

rPE3 has a density of 957.0 kg/m³, a MFR₂ of 0.32 g/10 min, a MFR₅ of 2.73 g/10 min and an amount of continuous C3 units (PP) of 6.94 wt.-%, determined by quantitative ¹³C{1H}-NMR measurement of the soluble fraction.

Recycled Polyethylene Fraction rPE4

rPE4 has a density of 950.7 kg/m³, a MFR₂ of 0.91 g/10 min, a MFR₅ of 4.23 g/10 min and an amount of continuous C3 units (PP) of 25.07 wt.-%, determined by quantitative ¹³C{1H}-NMR measurement of the soluble fraction.

### Virgin Polyethylenes (Component (B) or (B1))

### PE1

PE1 is a high density polyethylene containing carbon black, which has a density of 959.9 kg/m³, a MFR₂ of 0.5 g/10 min, a MFR₅ of 1.85 g/10 min, a STF value of 31.99 and an eta_{0.05} value of 26074 Pa·s. It is commercially available from Borealis AG, Wien under the designation HE6062.

### PE2

PE2 is a high density polyethylene of natural color, which has a density of 945.8 kg/m³, a MFR₂ of 0.55 g/10 min, a MFR₅ of 2.04 g/10 min, a STF value of 28.81 and an eta_{0.05} value of 21897 Pa·s. It is commercially available from Borealis AG, Wien under the designation HE6063.

### PE3

PE3 is a medium density polyethylene of natural color, which has a density of 936.0 kg/m³, a MFR₂ of 0.7 g/10 min, a MFR₅ of 3.0 g/10 min, a STF value of 26.42 and an eta_{0.05} value of 21583 Pa·s. It is commercially available from Borealis AG, Wien under the designation ME6053.

### PE4

PE4 is a linear low density polyethylene of natural color, which has a density of 924.8 kg/m³, a MFR₂ of 0.84 g/10 min, a MFR₅ of 3.38 g/10 min, a STF value of 29.49 and an eta_{0.05} value of 17695 Pa·s. It is commercially available from Borealis AG, Wien under the designation LE8706.

### PE5

PE5 is a medium density polyethylene of natural color, which has a density of 932.3 kg/m³, a MFR₂ of 0.24 g/10 min, a MFR₅ of 0.9 g/10 min, a STF value of 65.98 and an eta_{0.05} value of 61889 Pa·s. It is commercially available from Borealis AG, Wien under the designation FB2310.

### PE6

PE6 is a high density polyethylene of natural color, which has a density of 949.6 kg/m³, a MFR₂ of 0.05 g/10 min, a MFR₅ of 0.25 g/10 min, a STF value of 136.82 and an eta_{0.05} value of 175270 Pa·s. It is commercially available from Borealis AG, Wien under the designation HE3493-LS-H.

### PE7

PE7 is a high density polyethylene of natural color, which has a density of 956.9 kg/m³, a MFR₂ of 0.3 g/10 min, a MFR₅ of 1.17 g/10 min, a STF value of 40.75 and an eta_{0.05} value of 37364 Pa·s. It is commercially available from Borealis AG, Wien under the designation BB2581.

### PE8

PE8 is a high density polyethylene of natural color, which has a density of 954 kg/m³ and a MFR₂ of 0.3 g/10 min, a STF value of 43.80 and an eta_{0.05} value of 39948 Pa·s. It is commercially available from Borealis AG, Wien under the designation BB2541.

The properties of the recyclates (rPE1-3) and virgin polymers (PE1-8) are summarized in Table 1 below. “n.d.” in this and the following table means “non-determinable”.

TABLE 1

| | rPE1 | rPE2 | rPE3 | rPE4 | PE1 | PE2 |
|---|---|---|---|---|---|---|
| MFR₂ (g/10 min, | 0.39 | 0.32 | 0.55 | 0.91 | 0.5 | 0.55 |
| 190° C.) | | | | | | |
| MFR₅ (g/10 min, | 1.69 | 1.38 | 2.73 | 4.23 | 1.85 | 2.04 |
| 190° C.) | | | | | | |
| Density PE (kg/m³) | 961.5 | 958.1 | 957.0 | 950.7 | 959.9 | 945.8 |
| NMR LDPE in | n.d. | n.d. | n.d. | | n.d. | |
| C2 fraction (%) | | | | | | |
| NMR LDPE in | n.d | n.d. | n.d. | | n.d. | |
| total polymer (%) | | | | | | |
| NMR C2total (wt.-%) | 98.22 | 99.59 | 91.89 | 74.22 | 97.72 | |
| NMR C3total | n.d. | n.d. | 0.13 | 0.32 | n.d. | |
| (isolated | | | | | | |
| C3) (wt.-%) | | | | | | |
| NMR C4total (wt.-%) | 0.15 | 0.31 | 0.51 | 0.21 | 2.28 | |
| NMR C6total (wt.-%) | 0.17 | n.d. | 0.53 | 0.18 | n.d. | |
| NMR C7total (wt.-%) | n.d. | n.d. | n.d. | | n.d. | |
| NMR PPtotal | 1.45 | 0.1 | 6.94 | 25.07 | n.d. | |
| (continuous | | | | | | |
| C3) (wt.-%) | | | | | | |
| Impact strength | 4.11 | 5.87 | | | 4.51 | |
| 1eA −20° C. | | | | | | |
| (KJ/m²) | | | | | | |
| Impact strength | 4.08 | 6.18 | | | | |
| 1eA −30° C. | | | | | | |
| (KJ/m²) | | | | | | |
| Impact strength | 4.33 | 8.67 | | | 7.19 | |
| 1eA 0° C. | | | | | | |
| (KJ/m²) | | | | | | |
| DSC_Tc (° C.) | | | 119.3 | | | |
| DSC_Tm (° C.) | | | 131.8 | | | |
| Flexural | 866 | 937 | | | 1124 | |
| modulus (MPa) | | | | | | |
| Eta_{0.05}(Pa · s) | 35295 | 39868 | 28632 | 30107 | 26074 | 21897 |
| Eta₃₀₀ (Pa · s) | 745 | 832 | 597 | 561 | 815 | 760 |
| STF (Eta_{0.05}/Eta₃₀₀) | 47.38 | 47.92 | 47.96 | 53.67 | 31.99 | 28.81 |
| ISO 18553 | | | | | 2.5 | |
| CB rating | | | | | | |
| ISO 18553 | | | | | 1.83 | |
| WS rating | | | | | | |
| LAOS-NLF 1000% | 2.336 | 2.342 | | | | 1.919 |
| OCS_Contaminations_100- | 0 | 0 | 25.9 | 5 | | 0 |
| 299 μm (1/m²) | | | | | | |
| OCS_Contaminations_300- | 0 | 0 | 388.4 | 125.3 | | 0 |
| 599 μm (1/m²) | | | | | | |
| OCS_Contaminations_600- | 0 | 0 | 796.4 | 371.2 | | 0 |
| 1000 μm (1/m²) | | | | | | |
| OCS_Contaminations_>1000 μm (1/m²) | 0 | 0 | 386.8 | 402.6 | | 0 |
| OCS_Gel_100-299 μm (1/m²) | 11096.2 | 973.5 | 27592.4 | 29331.4 | | 7.1 |
| OCS_Gel_300-599 μm (1/m²) | 4912.7 | 283.1 | 8212.6 | 10726 | | 0.4 |
| OCS_Gel_600-1000 μm (1/m²) | 389.9 | 22 | 162.8 | 3323.1 | | 0.1 |
| OCS_Gel_>1000 μm (1/m²) | 71.3 | 1.6 | 2551.1 | 1326.6 | | 0 |
| OIT_200° C. (min) | 103.1 | 120.5 | | | | |
| SH modulus (MPa) | | | | | 25.38 | 27.43 |
| strain at break (%) | | | | | 822.47 | 880 |
| stress at break (MPa) | | | | | 28.14 | 33.66 |
| Aging at 110° | | | | | | 905.39 |
| C., 336 h strain | | | | | | |
| at break (%) | | | | | | |
| Aging at 110° | | | | | | 32.55 |
| C., 336 h stress | | | | | | |
| at break (MPa) | | | | | | |
| Shore D 15 s | 59.7 | 60.5 | | | 60.9 | 59.2 |
| Shore D 1 s | | | | | 64.1 | 62.3 |
| Shore D 3 s | | | | | 63 | 61.2 |
| TGA_CES_ash (wt.-%) | 0.76 | 0.1 | 0.84 | | | |
| TGA_carbon black (wt.-%) | | | | | 2.44 | |
| Tear resistance (N/mm) | | | | | 25.64 | 18.38 |
| Water content (ppm) | 137 | 138 | 232.3 | | 250 | |
| | PE3 | PE4 | PE5 | PE6 | PE7 | PE8 |
| MFR₂ (g/10 min, | 0.7 | 0.84 | 0.24 | 0.05 | 0.3 | 0.3 |
| 190° C.) | | | | | | |
| MFR₅ (g/10 min, | 3.0 | 3.38 | 0.9 | 0.25 | 1.17 | |
| 190° C.) | | | | | | |
| Density PE (kg/m³) | 936 | 924.8 | 932.3 | 949.6 | 956.9 | 954.0 |
| NMR LDPE in | | | | | | |
| C2 fraction (%) | | | | | | |
| NMR LDPE in | | | | | | |
| total polymer (%) | | | | | | |
| NMR C2total (wt.-%) | | | | | | |
| NMR C3total | | | | | | |
| (isolated | | | | | | |
| C3) (wt.-%) | | | | | | |
| NMR C4total (wt.-%) | | | | | | |
| NMR C6total (wt.-%) | | | | | | |
| NMR C7total (wt.-%) | | | | | | |
| NMR PPtotal | | | | | | |
| (continuous | | | | | | |
| C3) (wt.-%) | | | | | | |
| Impact strength | | | | | | |
| 1eA −20° C. | | | | | | |
| (KJ/m²) | | | | | | |
| Impact strength | | | | | | |
| 1eA −30° C. | | | | | | |
| (KJ/m²) | | | | | | |
| Impact strength | | | | | | |
| 1eA 0° C. | | | | | | |
| (KJ/m²) | | | | | | |
| DSC_Tc (° C.) | | | | | | |
| DSC_Tm (° C.) | | | | | | |
| Flexural | | | | | | |
| modulus (MPa) | | | | | | |
| Eta_{0.05}(Pa · s) | 21583 | 17695 | 61889 | 175270 | 37364 | 39948 |
| Eta₃₀₀ (Pa · s) | 817 | 600 | 938 | 1281 | 917 | 912 |
| STF (Eta_{0.05}/Eta₃₀₀) | 26.42 | 29.49 | 65.98 | 136.82 | 40.75 | 43.80 |
| ISO 18553 | | | | | | |
| CB rating | | | | | | |
| ISO 18553 | | | | | | |
| WS rating | | | | | | |
| LAOS-NLF 1000% | | 1.83 | | | 1.74 | |
| OCS_Contaminations_100- | | | | | | |
| 299 μm (1/m²) | | | | | | |
| OCS_Contaminations_300- | | | | | | |
| 599 μm (1/m²) | | | | | | |
| OCS_Contaminations_600- | | | | | | |
| 1000 μm (1/m²) | | | | | | |
| OCS_Contaminations_>1000 μm (1/m²) | | | | | | |
| OCS_Gel_100-299 μm (1/m²) | | | | | | |
| OCS_Gel_300-599 μm (1/m²) | | | | | | |
| OCS_Gel_600-1000 μm (1/m²) | | | | | | |
| OCS_Gel_>1000 μm (1/m²) | | | | | | |
| OIT_200° C. (min) | | | | | | |
| SH modulus (MPa) | | 16.62 | 37.99 | 83.7 | | |
| strain at break (%) | | | | | | |
| stress at break (MPa) | | | | | | |
| Aging at 110° | | | | | | |
| C., 336 h strain | | | | | | |
| at break (%) | | | | | | |
| Aging at 110° | | | | | | |
| C., 336 h stress | | | | | | |
| at break (MPa) | | | | | | |
| Shore D 15 s | | | | | | |
| Shore D 1 s | | | | | | |
| Shore D 3 s | | | | | | |
| TGA_CES_ash (wt.-%) | | | | | | |
| TGA_carbon black (wt.-%) | | | | | | |
| Tear resistance (N/mm) | | | | | | |
| Water content (ppm) | | | | | | |

### Other Ingredients

HE0880-A (Add1) is a HDPE-carbon black masterbatch composed of 40% carbon black.

IRGANOX® B225 FF (Add2) is a processing and long-term thermal stabilizer with high phenolic antioxidant content available from BASF, Ludwigshafen, Germany and is a blend of 50 wt.-% Irgafos® 168 and 50 wt.-% Irganox® 1010.

CEASIT AV/T (Add3) is a granular calcium stearate available from Baerlocher AG.

The blending of the recyclate fractions with the virgin polyethylenes was conducted on a Coperion W&P ZSK 32-mm co-rotating, twin-screw extruder at barrel temperatures of up to 230° C. and screw speed of 300 rpm.

The obtained polyethylene recyclate compositions and the measured results are shown in Table 2 below.

TABLE 2

| | IE1 | IE2 | CE1 | CE2 |
|---|---|---|---|---|
| rPE1 | 50 | 50 | | |
| rPE3 | | | 49.85 | |
| rPE4 | | | | 50 |
| PE2 | | 43.4 | | 43.7 |
| PE3 | 43.4 | | 43.4 | |
| Add1 | 6.6 | 6.6 | 6.6 | 6.3 |
| Add2 | | | 0.125 | |
| Add3 | | | 0.025 | |
| AO irgafos 168 (ppm) | 441 | 451 | 994 | |
| AO irganox 1010 (ppm) | 881 | 675 | 1272 | |
| Bell ESCR - Time | >5000 | >5000 | | 0 |
| for 0% failure (h) | | | | |
| Impact strength | 5.35 | 3.92 | 3.98 | |
| 1eA −20° C. (kJ/m²) | | | | |
| Impact strength | 4.27 | 3.87 | 3.72 | |
| 1eA −30° C. (kJ/m²) | | | | |
| Impact strength | 8.5 | 4.57 | 5.41 | 3.19 |
| 1eA 0° C. (kJ/m²) | | | | |
| Cable shrinkage (%) | 0.81 | | | |
| DSC_Tc (° C.) | 116.6 | 117 | 117.8 | |
| DSC_Tm (° C.) | 131.9 | 131.3 | 131.1 | |
| Density (kg/m³) | 962.4 | 967.1 | 959.9 | 960.1 |
| Flexural | 1080 | 1236 | 1058 | |
| modulus (MPa) | | | | |
| Eta_{0.05} (Pa · s) | 28937 | 35767 | 23155 | 27133 |
| Eta₃₀₀ (Pa · s) | 721 | 781 | 678 | 634 |
| STF (Eta_{0.05}/Eta₃₀₀) | 40.13 | 45.80 | 34.15 | 42.80 |
| ISO 18553 CB rating | 2.25 | 2 | 2.42 | |
| ISO 18553 WS rating | 2.33 | 3.17 | 5.5 | |
| LAOS-NLF 1000% | 3.492 | 2.759 | 3.049 | |
| MFR₂ (g/10 | 0.49 | 0.39 | 0.68 | 0.68 |
| min, 190° C.) | | | | |
| MFR₂₁ (g/10 | 44.32 | 36.06 | 53.82 | 60.81 |
| min, 190° C.) | | | | |
| MFR₅ (g/10 | 2.07 | 1.65 | 2.75 | 3.08 |
| min, 190° C.) | | | | |
| NMR LDPE in C2 | n.d. | n.d. | n.d. | n.d. |
| fraction (wt.-%) | | | | |
| NMR LDPE in total | n.d. | n.d. | n.d. | n.d. |
| polymer (wt.-%) | | | | |
| NMR C2total (wt.-%) | 96.94 | 98.22 | 93.85 | 87.07 |
| NMR C3total | n.d. | n.d. | 0.09 | 0.14 |
| (isolated C3) (wt.-%) | | | | |
| NMR C4total (wt.-%) | 2.48 | 1.15 | 2.39 | 1.1 |
| NMR C6total (wt.-%) | n.d | n.d. | 0.24 | n.d. |
| NMR C7total (wt.-%) | n.d. | n.d. | n.d. | n.d. |
| NMR PPtotal | 0.57 | 0.62 | 3.44 | 11.69 |
| (continuous C3) (wt.-%) | | | | |
| OIT 200° C. (min) | 113.9 | 106.5 | 84.7 | |
| SH modulus (MPa) | 16.51 | 17.77 | 15.25 | |
| strain at break (%) | 787.09 | 719.72 | 661.1 | 69.61 |
| stress at break (MPa) | 23.42 | 20.79 | 16.67 | 12.2 |
| Aged at 110° C., 336 | 792.03 | 786.98 | 581.53 | |
| h_strain at break (%) | | | | |
| Aged at 110° C., 336 | 20.6 | 15.61 | 12.47 | |
| h_stress at break (MPa) | | | | |
| Aged at 100° C., 240 | 811.98 | 547.63 | 547.78 | |
| h_strain at break (%) | | | | |
| Aged at 100° C., 240 | 22.12 | 13.38 | 11.42 | |
| h_stress at break (MPa) | | | | |
| Shore D 15 s | 60.2 | 61.4 | 59.4 | |
| Shore D 1 s | 63.9 | 65.2 | 63.4 | |
| Shore D 3 s | 62.4 | 63.7 | 61.4 | |
| TGA_ash | | | | |
| content (wt %) | | | | |
| TGA_carbon | 2.89 | 2.72 | 2.7 | |
| black (wt %) | | | | |
| Tear resistance (N/mm) | 27.87 | 27.47 | 25.81 | |
| Water content (ppm) | 123.5 | 128.6 | 75.8 | 136.6 |

The results of Table 2 show the impact of the higher purity of the recyclate fractions of IE1 and IE2 over those of CE1 and CE2 so as to achieve a superior combination of ESCR, stress and strain at break, tear resistance and optical properties (white spot rating) at comparable impact strength and stiffness.

TABLE 3

| | IE3 |
|---|---|
| rPE2 | 50 |
| PE3 | 43.4 |
| Add1 | 6.6 |
| AO irgafos 168 (ppm) | 422 |
| AO irganox 1010 (ppm) | 781 |
| Bell ESCR - Time for | >5000 |
| 0% failure (h) | |
| Impact strength | 6.29 |
| 1eA −20° C. (KJ/m²) | |
| Impact strength | 5.15 |
| 1eA −30° C. (KJ/m²) | |
| Impact strength | 13.93 |
| 1eA 0° C. (KJ/m²) | |
| Cable shrinkage (%) | 1.21 |
| DSC_Tc (° C.) | 117.4 |
| DSC_Tm (° C.) | 131.1 |
| Density PE (kg/m³) | 960.7 |
| Flexural modulus (MPa) | 1134 |
| Eta_{0.05} (Pa · s) | 30574 |
| Eta₃₀₀ (Pa · s) | 752 |
| STF (Eta_{0.05}/Eta₃₀₀) | 40.66 |
| ISO 18553 CB rating | 1.17 |
| ISO 18553 WS rating | 1.5 |
| LAOS-NLF 1000% | 3.193 |
| MFR₂ (g/10 min, 190° C.) | 0.46 |
| MFR₂₁ (g/10 min, 190° C.) | 42.38 |
| MFR₅ (g/10 min, 190° C.) | 2.02 |
| NMR LDPE in C2 | n.d. |
| fraction (%) | |
| NMR LDPE in | n.d. |
| total PO (%) | |
| NMR C2total (wt.-%) | 97.75 |
| NMR C3total | n.d. |
| (isolated C3) (wt.-%) | |
| NMR C4total (wt.-%) | 2.25 |
| NMR C6total (wt.-%) | n.d. |
| NMR C7total (wt.-%) | n.d. |
| NMR PPtotal | n.d. |
| (continuous C3) (wt.-%) | |
| OIT 200° C. (min) | 146 |
| SH modulus (MPa) | 17.59 |
| strain at break (%) | 878.41 |
| stress at break (MPa) | 28.9 |
| Aged at 110° C., 336 | 930.81 |
| h_strain at break (%) | |
| Aged at 110° C., 336 | 28.22 |
| h_stress at break (MPa) | |
| Aged at 100° C., 240 | 946.85 |
| h_strain at break (%) | |
| Aged at 100° C., 240 | 28.89 |
| h_stress at break (MPa) | |
| Shore D 15 s | 60.7 |
| Shore D 1 s | 64.5 |
| Shore D 3 s | 62.9 |
| TGA_carbon black (wt %) | 2.67 |
| Tear resistance (N/mm) | 28.94 |
| Water content (ppm) | 68 |

The results of Table 3 show the impact of the higher purity of the recyclate fractions in combination with the addition of a virgin polyethylene component of IE3 on the further improvement of impact strength, strain at break and optical performance (white spot rating), while ESCR was still excellent.

TABLE 4

| | IE4 | IE5 | IE6 | IE7 | IE8 | CE3 |
|---|---|---|---|---|---|---|
| rPE1 | 50 | 50 | 50 | 50 | 60 | 75 |
| PE3 | | | | 23.4 | | |
| PE4 | 43.4 | | 33.4 | 20 | 33.4 | 18.4 |
| PE5 | | 43.4 | | | | |
| PE6 | | | 10 | | | |
| Add1 | 6.6 | 6.6 | 6.6 | 6.6 | 6.6 | 6.6 |
| AO irgafos 168 (ppm) | 482 | 575 | 531 | 464 | 513 | 605 |
| AO irganox 1010 (ppm) | 1034 | 609 | 977 | 974 | 940 | 801 |
| Bell ESCR - Time | >5000 | >5000 | >5000 | >5000 | >5000 | 4800 |
| for 0% failure (h) | | | | | | |
| Impact strength | 5.08 | 5.95 | 5.01 | 5.5 | 4.61 | 4.01 |
| 1eA -20° C. (KJ/m²) | | | | | | |
| Impact strength | 5.07 | 4.5 | 4.44 | 4.42 | 4.06 | 3.96 |
| 1eA -30° C. (KJ/m²) | | | | | | |
| Impact strength | 7.97 | 13.17 | 6.71 | 8.26 | 6.11 | 4.48 |
| 1eA 0° C. (KJ/m²) | | | | | | |
| Cable shrinkage (%) | 0.72 | 1.65 | 0.69 | 1.11 | 0.93 | 0.61 |
| DSC_Tc (° C.) | 116.9 | 116.8 | 116.7 | 117.1 | 117.3 | 117.4 |
| DSC_Tm (° C.) | 130 | 130.8 | 130.9 | 130.5 | 130.6 | 131.3 |
| Density (kg/m³) | 957.3 | 960.8 | 960.1 | 959.3 | 961.1 | 967 |
| Flexural modulus (MPa) | 924 | 1032 | 997 | 1010 | 996 | 1135 |
| Eta_{0.05} (Pa · s) | 28900 | 50642 | 41244 | 29528 | 31391 | 34643 |
| Eta₃₀₀ (Pa · s) | 693 | 819 | 752 | 720 | 703 | 731 |
| STF (Eta_{0.05}/Eta₃₀₀) | 41.70 | 61.83 | 54.85 | 41.01 | 44.65 | 47.39 |
| ISO 18553 CB rating | 2 | 2.25 | 2.17 | 2.25 | 2.42 | 2.42 |
| ISO 18553 WS rating | 2.67 | 2.67 | 3.5 | 2.67 | 3.58 | 2.83 |
| LAOS-NLF 1000% | 2.914 | 2.914 | 2.921 | 2.901 | 2.838 | 2.888 |
| MFR₂ (g/10 min, 190° C.) | 0.5 | 0.27 | 0.35 | 0.51 | 0.49 | 0.47 |
| MFR₂₁ (g/10 min, 190° C.) | 46.39 | 27.1 | 37.44 | 44.08 | 42.12 | 41.36 |
| MFR₅ (g/10 min, 190° C.) | 2.01 | 1.1 | 1.53 | 2.22 | 1.99 | 1.9 |
| NMR LDPE in | n.d. | n.d. | n.d. | n.d. | n.d. | n.d. |
| C2 fraction (%) | | | | | | |
| NMR LDPE in | n.d. | n.d. | n.d. | n.d. | n.d. | n.d. |
| total polymer (%) | | | | | | |
| NMR C2total (wt.-%) | 96.17 | 96.85 | 96.32 | 96.68 | 96.51 | 97.28 |
| NMR C3total | n.d. | n.d. | n.d | n.d. | n.d. | n.d. |
| (isolated C3) (wt.-%) | | | | | | |
| NMR C4total (wt.-%) | 3.31 | 2.58 | 2.61 | 2.74 | 2.69 | 1.71 |
| NMR C6total (wt.-%) | n.d | n.d. | 0.38 | n.d. | n.d. | n.d. |
| NMR C7total (wt.-%) | n.d. | n.d. | n.d. | n.d. | n.d | n.d. |
| NMR PPtotal | 0.52 | 0.57 | 0.69 | 0.58 | 0.8 | 1.01 |
| (continuous C3) (wt.-%) | | | | | | |
| OIT 200° C. (min) | 117 | 66.2 | 122.7 | 109.5 | 107.5 | 110.4 |
| SH modulus (MPa) | 14.66 | 21.04 | 16.82 | 15.78 | 14.66 | 14.31 |
| strain at break (%) | 804.88 | 751.31 | 851.56 | 819.9 | 774.73 | 693.08 |
| stress at break (MPa) | 22.22 | 24.6 | 24.87 | 22.98 | 19.98 | 18.47 |
| Aged at 110° C., | 823.35 | 760.52 | 798.58 | 859.19 | 833.19 | 407.84 |
| 336 h_strain at | | | | | | |
| break (%) | | | | | | |
| Aged at 110° C., | 21.49 | 23 | 21.36 | 23.35 | 18.73 | 12.36 |
| 336 h_stress at | | | | | | |
| break (MPa) | | | | | | |
| Aged at 100° C., | 896.45 | 820.91 | 769.14 | 758.73 | 732.21 | 481.64 |
| 240 h_strain at | | | | | | |
| break (%) | | | | | | |
| Aged at 100° C., | 23.36 | 26.1 | 21.26 | 20.41 | 17 | 12.55 |
| 240 h_stress at | | | | | | |
| break (MPa) | | | | | | |
| Shore D 15 s | 57.5 | 59.3 | 58.6 | 58.8 | 58.8 | 60.4 |
| Shore D 1 s | 61.7 | 63.1 | 62.8 | 62.7 | 62.9 | 64.3 |
| Shore D 3 s | 60 | 61.9 | 61.3 | 61.2 | 61.1 | 62.9 |
| TGA_carbon black (wt %) | 2.72 | 2.68 | 2.65 | 2.58 | 2.7 | 2.72 |
| Tear resistance (N/mm) | 26.31 | 27.34 | 26.84 | 27.22 | 26.95 | 27.31 |
| Water content (ppm) | 116.5 | 105.4 | 167.3 | 152.8 | 164.5 | 144.2 |

The results of Table 4 show the impact of a recyclate fraction having high purity in a lower weight proportion in combination with the addition of a virgin polyethylene having a lower density on the improvement of stress and strain at break, impact strength and ESCR.

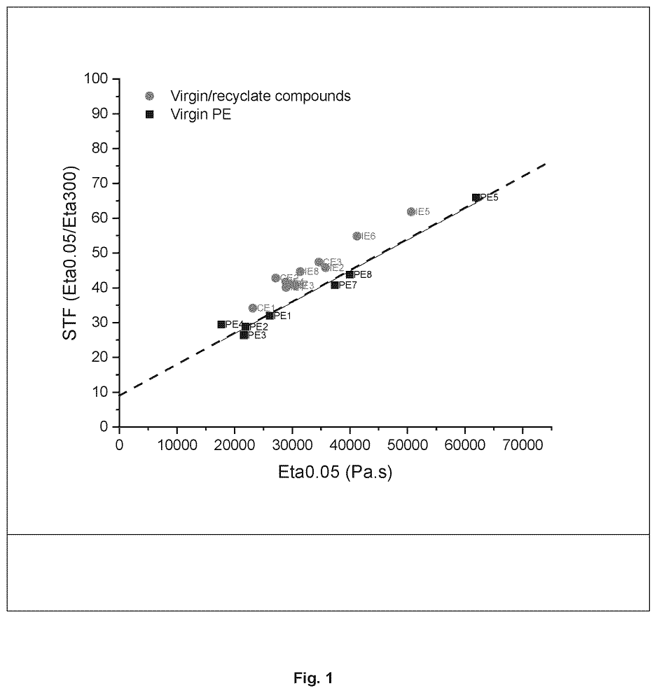

FIG. 1 illustrates strain hardening factor (STF) as a function of Eta_{0.05} of the recyclate compositions of the examples vs. the virgin polyethylene components (B)/(B1) alone to express processability of the samples at a given complex viscosity.

For virgin PE a correlation between STF and Eta_{0.05} is observed in the complex shear viscosity at an angular frequency of 0.05 rad/s (Eta_{0.05}) within a range of from 10,000 to 70,000 Pa·s, according to the following equation:

$$STF = 0.0009 * {Eta}_{0.05} ( Pa \cdot s ) + 9.$$

Surprisingly, the prepared mixed-plastic recyclate polyethylene compositions of the present invention comprising a blend of a recycled polyethylene fraction (rPE) with at least one virgin polyethylene (B) and optionally (B1) show higher STF at a given complex shear viscosity (Eta_{0.05}), i.e.,

$$STF = 0.0009 * {Eta}_{0.05} ( Pa \cdot s ) + 9.$$

This suggests more pronounced shear thinning than the virgin PE components alone, and therefore the mixed-plastic recyclate polyethylene compositions of the present invention show improved processability.

1. A mixed-plastic recyclate polyethylene composition having a melt flow rate (ISO 1133, 2.16 kg, 190° C.) of from 0.1 to 1.5 g/10 min; and a density (ISO 1183) of from 938 to 985 kg/m³, and comprising 35 wt.-% or more of a recycled polyethylene fraction (rPE);
wherein the mixed-plastic recyclate polyethylene composition has:
(a) a total amount of ethylene units (C2 units) of at least 95.0 wt.-%, as measured by ¹³C-NMR of the d2-tetrachloroethylene soluble fraction, as described herein;
(b) a total amount of continuous C3 units originating from polypropylene (PP) in an amount of from Oto 3.0 wt.-%, determined by quantitative ¹³C{1H}-NMR measurement of the soluble fraction, as described herein; and
(c) an environmental stress crack resistance (ESCR) according to the Bell test, in accordance with IEC 60811-406, method B and as described herein of at least 1000 hours failure time,
wherein the mixed-plastic recyclate polyethylene composition further comprises:
at least one virgin polyethylene component (B), optionally blended with carbon black, and
optionally a virgin polyethylene component (B1), different from virgin polyethylene component (B), optionally blended with carbon black,
wherein the mixed-plastic recyclate polyethylene composition has a tear resistance, determined according to BS 6469 section 99.1 of at least 24 N/mm.

2. A mixed-plastic recyclate polyethylene composition, obtainable or obtained according to a method comprising the steps of melting, blending and extruding in an extruder, with a screw speed of not more than 400 rpm of at least 35.0 wt.-% of the recycled polyethylene fraction (rPE), and at least 20 wt.-% of a virgin polyethylene component, selected from at least one virgin polyethylene component (B) optionally blended with carbon black, and a virgin polyethylene component (B1), different from virgin polyethylene component (B), optionally blended with carbon black.

3. The mixed-plastic recyclate polyethylene composition according to claim 1, wherein the at least one virgin polyethylene component (B) has a melt flow rate (ISO 1133, 2.16 kg, 190° C.) of from 0.01 to 1.2 g/10 min and a density (ISO 1183) of from 920 to 970 kg/m3, and/or
the virgin polyethylene component (B1) has a melt flow rate (ISO 1133, 2.16 kg, 190° C.) of from 0.04 to 0.8 g/10 min, and a density (ISO 1183) of from 930 to 965 kg/m³.

4. The mixed-plastic recyclate polyethylene composition according to claim 1 having a strain hardening modulus, determined according to ISO 18488 and as described herein, of 10 MPa or higher, and/or
having a Shore D hardness (15 s), determined according to ISO 868 and as described herein, of at least 57.

5. The mixed-plastic recyclate polyethylene composition according to claim 1, having a relationship between strain hardening factor (STF) and complex shear viscosity at an angular frequency of 0.05 rad/s (Etao.os), determined as described herein, of
$$STF = 0.0009 * {Eta}_{0.05} ( Pa \cdot s ) + 9$$
wherein Etao.os is in a range of from 10,000 to 100,000 Pa·s.

6. The mixed-plastic recyclate polyethylene composition according to claim 1 having a white spot rating (WSR), determined according ISO 18553 and as described herein, of not more than 5.0.

7. The mixed-plastic recyclate polyethylene composition according to claim 1 having a tensile strain at break, determined according to ISO 527-2 on compression moulded 5 A specimens of at least 670%.

8. The mixed-plastic recyclate polyethylene composition according to claim 1, wherein any one of the at least one virgin polyethylene component (B) and the virgin polyethylene component (B1) is a bimodal polyethylene.

9. The mixed-plastic recyclate polyethylene composition according to claim 1 comprising not more than 70 wt.-% of recycled polyethylene fraction (rPE) as defined in claim 1, and said at least one virgin polyethylene component (B) and/or said virgin high density polyethylene component (B1) having a density (ISO 1183) of not more than 942 kg/m³.

10. The mixed-plastic recyclate polyethylene composition according to claim 1 having a Large Amplitude Oscillatory Shear-Non-Linear Factor (LAOS-NLF), determined at 190° C. and a strain of 1000%, as described herein
$$LAOS - NLF = 1 : i \vert$$
whereby
G1′ is the first order Fourier Coefficient
G3′ is the third order Fourier Coefficient
in the range of 2.0 to 4.0.

11. The recycled polyethylene fraction (rPE) as defined in claim 1, obtainable or obtained by a method of recycling a mixed-plastic recycling stream comprising the steps of:
a) providing a mixed-plastic recycling stream (A);
b) sieving the mixed-plastic recycling stream (A) to create a sieved mixed-plastic recycling stream (B) having only articles with a longest dimension in the range from 30 to 400 mm;
c) sorting the sieved mixed-plastic recycling stream (B) by means of one or more sorting systems equipped with near infrared (NIR) and optical sensors wherein the sieved mixed-plastic recycling stream (B) is sorted at least by polymer type and color, generating a mixed-color sorted or natural or white color-sorted polyethylene recycling stream (CM) that is subjected separately to steps d) and beyond;
d) shredding the sorted polyethylene recycling stream (CM) to form a flaked polyethylene recycling stream (D);
e) washing the flaked polyethylene recycling stream (D) with a first aqueous washing solution (W1) without the input of thermal energy, thereby generating a first suspended polyethylene recycling stream (E);
f) removing at least part of the first aqueous washing solution (W1) from the first suspended polyethylene recycling stream (E) to obtain a first washed polyethylene recycling stream (F);
g) washing the first washed polyethylene recycling stream (F) with a second aqueous washing solution (W2) thereby generating a second suspended polyethylene recycling stream (G), wherein sufficient thermal energy is introduced to the second suspended polyethylene recycling stream (G) to provide a temperature in the range from 65 to 95° C. during the washing;
h) removing the second aqueous washing solution (W2) and any material not floating on the surface of the second aqueous washing solution from the second suspended polyethylene recycling stream (G) to obtain a second washed polyethylene recycling stream (H);
i) drying the second washed polyethylene recycling stream (H), thereby obtaining a dried polyethylene recycling stream (I);
j) optionally separating the dried polyethylene recycling stream (I) into a light fraction and a heavy fraction polyethylene recycling stream (J) by windsifting;
k) optionally sieving the polyethylene recycling stream;
l) optionally further sorting the heavy fraction polyethylene recycling stream (J) or, in the case that step j) is absent, the dried polyethylene recycling stream (I) by means of one or more optical sorters sorting for one or more target polyethylenes by removing any flakes containing material other than the one or more target polyethylenes, yielding a purified polyethylene recycling stream (K);
m) optionally melt extruding the purified polyethylene recycling stream (K) to form an extruded recycled polyethylene product (L); and
n) optionally aerating the recycled polyethylene product (L) or, in the case that step I) is absent, the purified polyethylene recycling stream (K) to remove volatile organic compounds, thereby generating an aerated recycled polyethylene product (M), being either an aerated extruded recycled polyethylene product (M1) or aerated recycled polyethylene flakes (M2),
wherein the order of steps n) and m) can be interchanged, such that the purified polyethylene recycling stream (K) is first aerated to form aerated recycled polyethylene flakes (M2) that are subsequently extruded to form an extruded aerated recycled polyethylene product (M3), which is the recycled polyethylene fraction (rPE) as defined in claim 1.

12. The recycled polyethylene fraction (rPE) according to claim 11, having a total amount of continuous C3 units originating from polypropylene (PP) in an amount of not more than 1.0 wt. %, determined by quantitative 13C{1H}-NMR measurement of the soluble fraction, as described herein.

13. A method of preparing the mixed-plastic recyclate polyethylene composition according to claim 1, comprising the steps of melting, blending and extruding the recycled polyethylene fraction (rPE), the at least one virgin polyethylene component (B), and optionally the virgin polyethylene component (B1) in an extruder, with a screw speed of not more than 400 rpm.

14. Article made from the mixed-plastic recyclate polyethylene composition according to claim 1, whereby said mixed-plastic recyclate polyethylene composition amounts to at least 85 wt.-% of the total composition for making the article.

15. A method, comprising extruding the mixed-plastic recyclate polyethylene composition according to claim 1 to form a layer of a wire or cable.
